(19) United States
(12) Patent Application Publication
(10) Pub. No.: US 2021/0094148 A1
(43) Pub. Date: Apr. 1, 2021

(54) PLUNGE DRESSING METHODS AND SYSTEMS FOR PRODUCING A GRINDING WHEEL FOR SPIRAL-BEVEL AND HYPOID GEAR MANUFACTURE

(71) Applicant: Hastings Wyman, Saline, MI (US)

(72) Inventor: Hastings Wyman, Saline, MI (US)

(21) Appl. No.: 17/035,547

(22) Filed: Sep. 28, 2020

Related U.S. Application Data
(60) Provisional application No. 62/906,957, filed on Sep. 27, 2019.

(51) Int. Cl. B24B 53/085; B23F 9/02; B23F 23/12; B24B 53/12; B24B 49/18

(52) U.S. Cl. CPC B24B 53/085; B23F 9/025; B24B 49/18; B24B 53/12; B23F 23/1225

(57) ABSTRACT

Method and systems are disclosed for plunge dressing of a spiral bevel gear-grinding wheel. The method includes providing a dressing roll for plunge dressing of a spiral bevel gear-grinding wheel, the dressing roll including: a body portion having an axis of rotation, a radial extent about said axis, and an axial extent, the body portion integrally comprising: a base portion configured for connection to a drive motor, a first cutting surface, and a second cutting surface, and plunge dressing of the spiral bevel gear-grinding wheel based upon the interference calculation. Some embodiments include determining whether interference will occur between the grinding wheel and the dressing roll before plunge dressing.

### CROSS REFERENCE TO RELATED APPLICATIONS

This application claims the benefit of Provisional Application No. 62/906,957 filed on Sep. 27, 2019 which is hereby incorporated herein by reference.

### TECHNICAL FIELD

This disclosure relates to methods and systems for producing a grinding wheel, and more particularly to plunge dressing methods and systems for producing a grinding wheel for spiral-bevel and hypoid gear manufacture.

### BACKGROUND

The statements in this section merely provide background information related to the present disclosure and may not constitute prior art.

Ground tooth spiral bevels have historically been expensive to manufacture, and thus typically used in high-performance and less cost-sensitive applications, for example the aerospace field. Over the past several decades various factors, such as CNC and grinding wheel technology development, have reduced the manufacturing cost of ground tooth spiral-bevel gears to the point where tooth grinding has made significant inroads into higher volume and cost-sensitive applications, e.g. automotive applications. In the automotive manufacturing space, cost and process stability are major motivating concerns when selecting manufacturing processes.

One major cost driver in automotive gear manufacturing is cycle time, variously defined as the amount of time it takes for a machine to perform a manufacturing operation. Cycle time improvement is a significant source of development effort. Cycle time can further be broken down into so-called “machining time”, where a tool is actually engaged with a workpiece, and “auxiliary time”, which is all of the other time a machine requires to process a workpiece, i.e. loading time, internal machine movement time, part locating time, etc. Historically, the ratio of machining time to auxiliary time in gear manufacturing operations was approximately 90% machining time and 10% auxiliary time. Various recent developments have reduced the machining time so that the ratio is now approximately 70% machining time and 30% auxiliary time. To reduce auxiliary time, recent developments have focused on developing multi-workpiece-spindle machines, integrated loading/unloading automation, higher acceleration linear motors, and machine movement optimization.

In spiral-bevel and hypoid gear tooth grinding, dressing of gear grinding wheels is currently a significant contributor to auxiliary time. Even when optimized, workpiece quality requirements require dressing process parameters that can take 5-10 seconds, or longer depending on the particular application. Various grinding approaches can perform the dressing operation in parallel with part loading and unloading, but this is not always practical with all machine and automation designs.

While various approaches have existed for spiral-bevel gear grinding (e.g. flared-cup grinding), the most common approach currently applied in industry today uses cylindrical cup-shaped grinding wheels, dressed online (e.g. in the CNC grinding machine) to a desired profile shape. The grinding wheels are typically glued to a mild steel backing plate which is used to mount the grinding wheel in the machine via one of various tooling interfaces. After the initial dressing, as the grinding wheel becomes dull or worn with use, it is periodically re-dressed back to the original desired profile. With each re-dressing, the grinding wheel become shorter, until it becomes too short to be re-dressed, at which point it is removed from the grinding machine and discarded or recycled.

The profile which is dressed into the grinding wheel is typically specific to a member (e.g. either pinion or gear) of a particular gear summary. That is, every pinion or gear design is associated with a grinding wheel profile. Exceptions do occur, as for example commonized tooling designs across multiple ratios within a spiral-bevel gear family. But, generally speaking, there are not standard grinding wheel profiles applied in spiral-bevel gear grinding. As such, each part has its own highly engineered grinding wheel dressing profile, with specific characteristics. There are various profile definition schemes in use, but these grinding wheel profile schemes generally follow a format similar to that in FIG. 2 for a grinding wheel, viewed through a diametral planar section.

In order to achieve such very specific grinding wheel dressing profiles, known CNC spiral-bevel grinding machines move a rotary dressing roll along a path on the grinding wheel using a combination of multiple axes to generate the desired profile. A typical path to achieve this is depicted in FIG. 1. These known methods all have point contact between the radiused tip of the dressing roll and the grinding wheel, including in the areas of the grinding wheel tip radius and flank. These methods dress the inside (concave) and outside (convex) grinding wheel surfaces using two distinct dressing paths generated by the CNC controller.

The feed rate that the dressing roll moves across the dressing path must be carefully controlled to create sufficient overlap between revolutions of the grinding wheel. Using too fast a feed rate will create a rough surface (feed marks) on the grinding wheel which can cause undesirable surface finish on the workpiece gear, and can lead to early breakdown of the grinding wheel form, which can cause undesirable tooth size and pitch error on the workpiece gear. This reduces the maximum feed rate at which the dressing operation can be performed, creating a lower limit on how much time the dressing operation will take. For example, the grinding wheel for a spiral-bevel gear with a whole depth of ˜13 mm will have a combined dressing path length of ˜46 mm. At a dressing feed rate of 200 mm/minute, the dressing feed alone will take ˜14 seconds, not including rapid machine movements for resetting the dressing roll position between dressing paths. At a dressing feed rate of 150 mm/minute, the dressing feed alone will take ˜18 seconds, not including rapid machine movements for resetting the dressing roll position between dressing paths.

Creating the most exact grinding wheel profile depends on knowing the exact shape and size of the radiused tip of the dressing roll. When a new dressing roll is made, extreme care is taken to ensure that this shape is an arc of a circle (swept, a toroidal surface) and the radius of this arc of a circle is entered into the CNC controller of the grinding machine. Despite the use of the latest developments in CVD diamond and other super hard materials, with prolonged use this radius can become worn, changing both size and shape. Unless these changes are measured and the corresponding values entered into the CNC controller, a worn dressing roll will not create the same grinding wheel profile as a new (or newly requalified) dressing roll. Important to note is that in mass production of one or a limited range of part designs, the dressing roll wear is typically not evenly distributed around the dressing roll tip radius, but rather is concentrated in one or two areas, and affects the shape as well as the size of the dressing roll tip radius, often “flat spotting” the original pure radius into a faceted shape. It is difficult to compensate for this common faceted wear. This faceted wear causes long-term process variation, which can be difficult to realize, diagnose, and correct.

When a new grinding wheel is fitted to a spiral-bevel grinding machine, the wheel must undergo an initial dressing operation before it can be put into service. This initial dressing typically removes much more grinding wheel material than a normal redressing. As such, the initial dressing operation requires much more time and care to carry out. Recognizing this, many grinding wheel suppliers deliver cup grinding wheels for spiral-bevel gear grinding with some type of pre-profiling. This reduces the amount of grinding wheel material that must be removed in the initial dressing, but it does not eliminate it.

Removing this substantial initial dressing material with repeated point-contact dressing paths results in both a significant amount of “air-dressing”, where the dressing roll is feeding while not in contact with the grinding wheel, and wear concentration on a particular point of the dressing roll tip radius.

The root radius of a ground spiral-bevel gear is a critical part characteristic which has a strong effect on the bending fatigue strength of the gear. The root radius of a ground gear is created by the tip radius of the grinding wheel. In typical state-of-the-art spiral-bevel gear grinding, the dressing roll generates the tip radius of the grinding wheel via a CNC controlled path motion of the tip radius of the dressing roll over the tip radius of the grinding wheel. In order to ensure the most accurate radius creation, the machine feed rate along this path is typically limited. If too high a feed rate is used to generate the grinding wheel tip radius, radius inaccuracies can result. This effect is magnified by the faceted wear phenomenon described above. This can have negative impacts on the ability of the spiral-bevel gear grinding process to produce a consistent root radius.

Therefore, a need exists to reduce the time required for the dressing operation in spiral bevel and hypoid grinding and increase the quality and consistency of the dressing.

### SUMMARY

Methods and systems are disclosed for plunge dressing of a spiral bevel gear-grinding wheel. One method includes providing a dressing roll for plunge dressing of a spiral bevel gear-grinding wheel, the dressing roll including: a body portion having an axis of rotation, a radial extent about said axis, and an axial extent, the body portion integrally comprising: a base portion configured for connection to a drive motor, a first cutting surface, and a second cutting surface, and plunge dressing of the spiral bevel gear-grinding wheel based upon the interference calculation.

Further embodiments include determining whether interference will occur between the grinding wheel and the dressing roll before plunge dressing.

### BRIEF DESCRIPTION OF THE DRAWINGS

One or more embodiments will now be described, by way of example, with reference to the accompanying drawings, in which:

FIGS. 1A and 1B schematically show exemplary systems for plunge dressing of a spiral bevel gear-grinding wheel, in accordance with the present disclosure;

FIGS. 1C-7 illustrate dressing using a point contact method; nomenclature in FIG. 2 is the same for the outside (convex) grinding wheel surface (omitted for clarity purposes);

FIG. 8 illustrates a first embodiment for plunge dressing of a spiral bevel gear-grinding wheel wherein the dressing roll changes position between an inside (concave) and outside (convex) positions;

FIG. 9 illustrates a second embodiment for plunge dressing of a spiral bevel gear-grinding wheel wherein the dressing roll changes position between an inside (concave) and outside (convex) positions;

FIG. 10 illustrates a third embodiment for plunge dressing of a spiral bevel gear-grinding wheel wherein the dressing roll dressing both inside (concave) and outside (convex) grinding surfaces in one position;

FIG. 11 illustrates a fourth embodiment for plunge dressing of a spiral bevel gear-grinding wheel wherein the dressing roll or the grinding wheel are tilted for line contact;

FIG. 12 illustrates a fifth embodiment for plunge dressing of a spiral bevel gear-grinding wheel wherein the dressing roll changes position between inside (concave) and outside (convex) dressing operations;

FIG. 13 illustrates a sixth embodiment for plunge dressing of a spiral bevel gear-grinding wheel wherein the dressing roll changes position between inside (concave) and outside (convex) dressing operations;

FIG. 14 illustrates a seventh embodiment for plunge dressing of a spiral bevel gear-grinding wheel in a single plunge;

FIG. 15 illustrates an eighth embodiment for plunge dressing of a spiral bevel gear-grinding wheel in a single plunge wherein either or both of the dressing roll and the grinding wheel change position between inside (concave) and outside (convex) dressing operations;

FIG. 16 depicts an exemplary area on a grinding wheel where interference by the dressing roll can occur;

FIG. 17 shows an exemplary process for plunge dressing of a spiral bevel gear-grinding wheel using an exemplary system;

FIGS. 18-20 illustrates various exemplary information for assessing interference between the dressing roll and the grinding wheel;

FIGS. 21A-21B depict a table having exemplary information for X, Y, Z coordinates for each circular dressing roll section;

FIG. 22 is an exemplary grinding wheel showing an exemplary calculations corresponding grinding wheel diameter and Z values at X, Y points from the table shown in FIGS. 21A and 21B;

FIGS. 23A and 23B shows a table of exemplary information from calculating corresponding grinding wheel diameter and Z values at X, Y points from the table shown in FIGS. 21A and 21B;

FIG. 24 shows a table of exemplary interference information between dressing roll X, Y, Z points and grinding wheel X, Y, Z points;

FIGS. 25-26 illustrates various exemplary information for assessing interference between the dressing roll and the grinding wheel;

FIG. 27 illustrates various positioning techniques when executing plunge dressing of the grinding wheel;

FIGS. 28-30 illustrate exemplary techniques for initial dressing a new grinding wheel;

FIGS. 31-32 illustrate exemplary plunge dressings;

FIG. 33 illustrates an exemplary plunge dressing combined with a point contact technique;

FIGS. 34-35 illustrate plunge dressing combined with side shift positioning of the dressing roll; and

FIG. 36 depicts a difference in shoulder radius cuts between a plunge dressing technique and a point contact technique.

### DETAILED DESCRIPTION

Reference throughout this specification to “one embodiment,” “an embodiment,” or similar language means that a particular feature, structure, or characteristic described in connection with the embodiment is included in at least one embodiment of the subject matter of the present disclosure. Appearances of the phrases “in one embodiment,” “in an embodiment,” and similar language throughout this specification may, but do not necessarily, all refer to the same embodiment.

Various embodiments of the present invention will be described in detail with reference to the drawings, where like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” The term “based upon” is not exclusive and allows for being based on additional factors not described, unless the context clearly dictates otherwise. Additionally, in the subject description, the word “exemplary” is used to mean serving as an example, instance or illustration. Any embodiment or design described herein as “exemplary” is not necessarily to be construed as preferred or advantageous over other embodiments or designs. Rather, use of the word exemplary is intended to present concepts in a concrete manner.

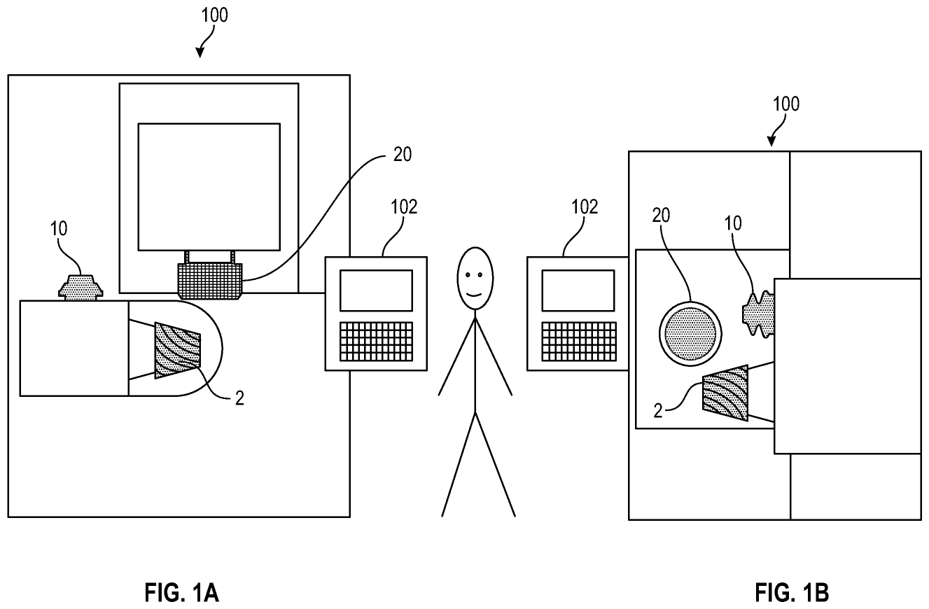

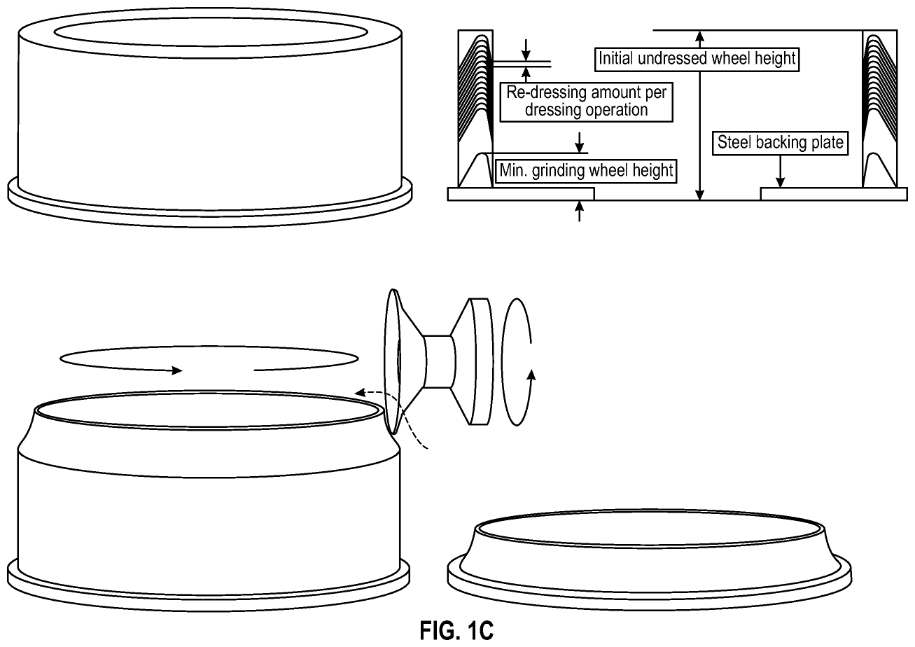

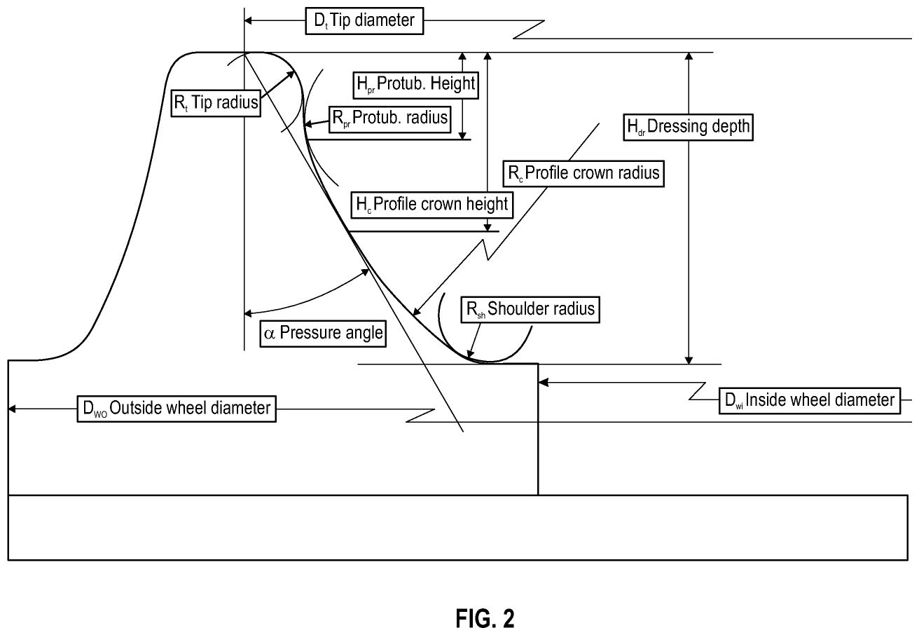

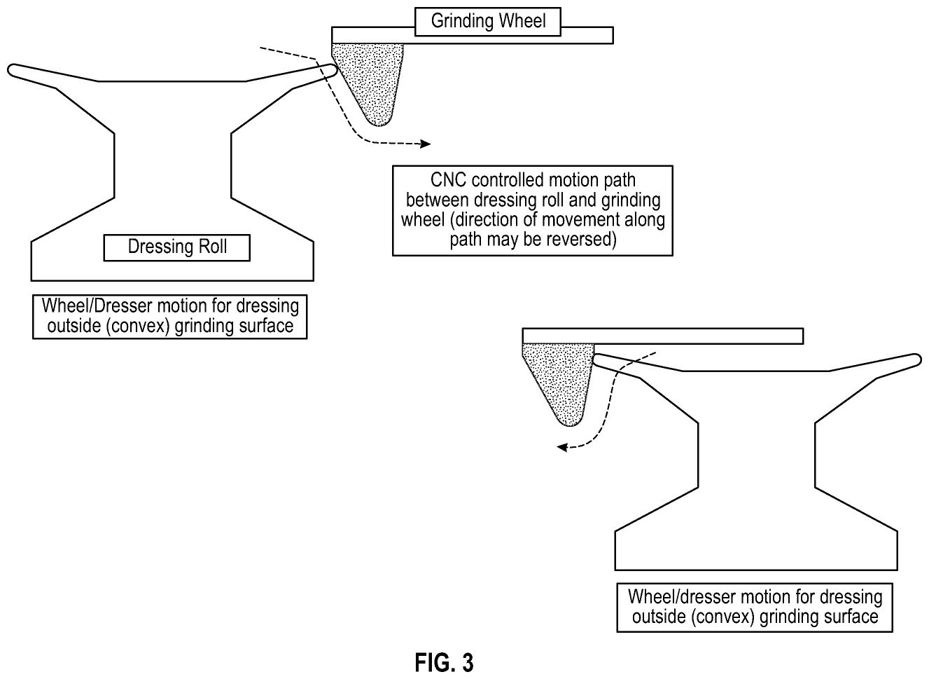

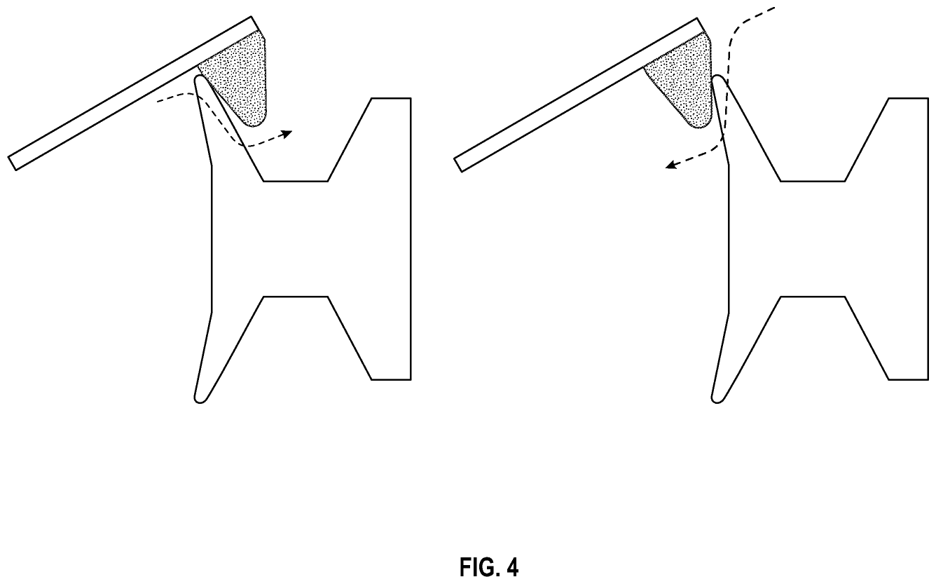

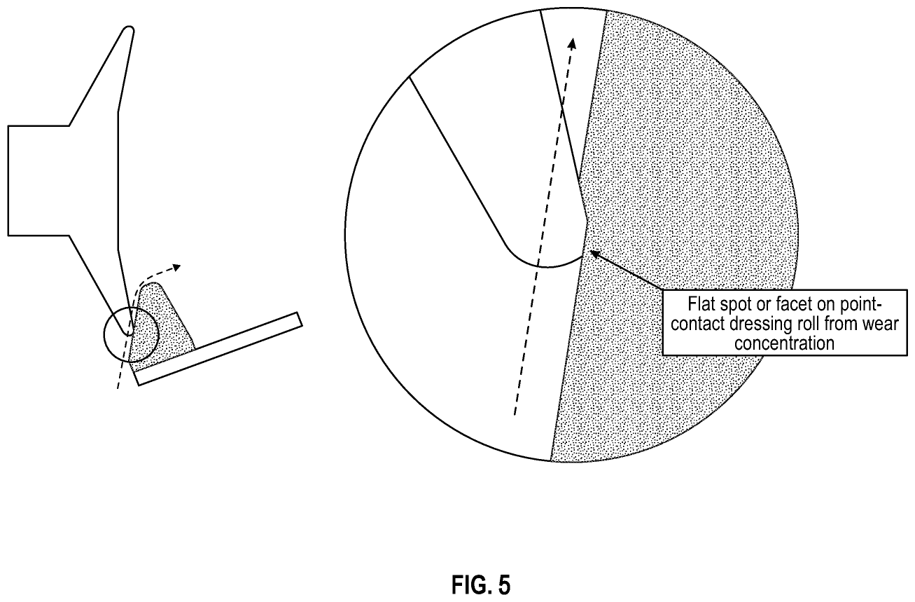

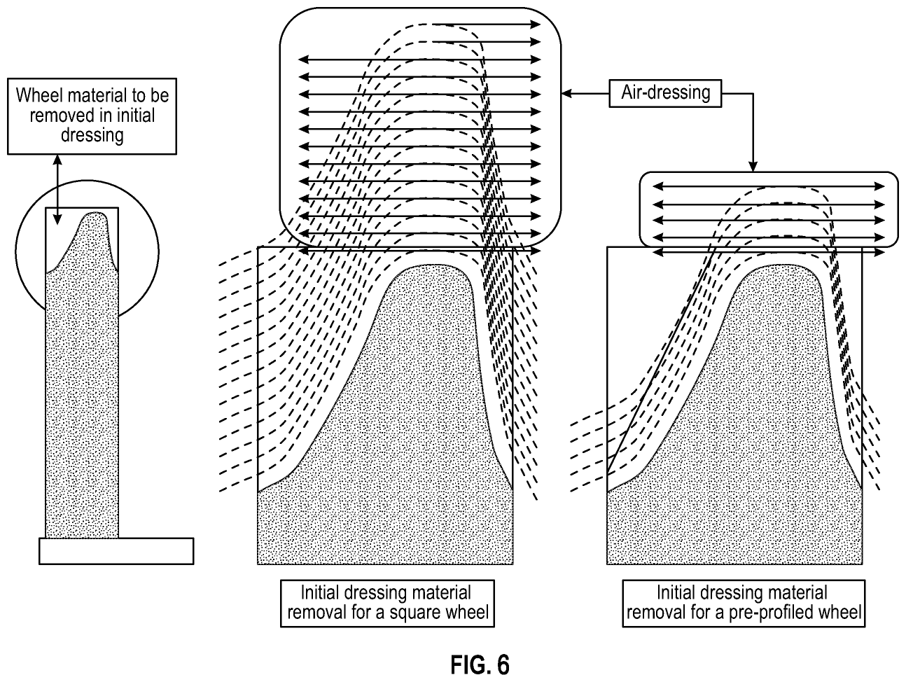

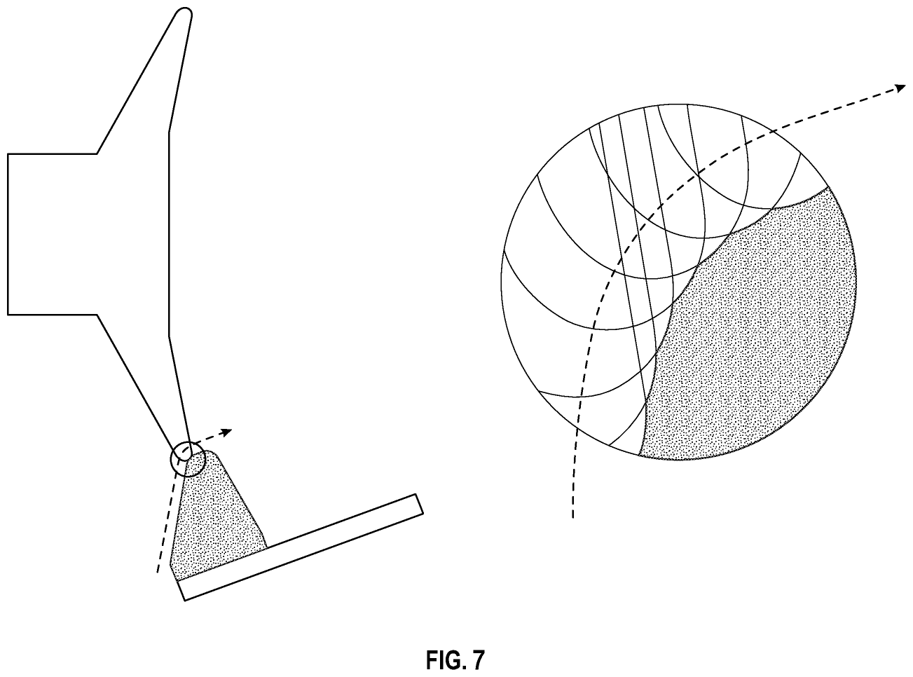

Referring now to the drawings, wherein the depictions are for the purpose of illustrating certain exemplary embodiments only and not for the purpose of limiting the same, FIG. 1A shows an exemplary “vertical” spiral-bevel grinding system 100 and FIG. 1B shows an exemplary “horizontal” spiral-bevel grinding system 100, which each may help implement the methodologies of the present disclosure, which may include forming a spiral-bevel and hypoid gear 2.

The system 100 includes a dressing roll 10, and a substantially cup-shaped grinding wheel 20, and a controller 102. As known in the art, the dressing roll 10 and the grinding wheel 20 are mounted on appropriate supports for selective and controlled rotation. Drive motors or similar are preferably connected to the controller 102 and controllable thereby. The particular dressing roll 10 and grinding wheel 20 shown are exemplary.

The particular devices used to position, and rotate, and move the dressing roll 10 and the grinding wheel 20 may be of any conventional design presently used in the art and controllable by the controller 102. For example, a mechanical arm may be utilized to move the dressing roll 10 along all three translational axes. Further embodiments of the system can include devices and mechanical features to move the grinding wheel along one or more axes.

Operation of drive motors are controlled by the controller 102 or other control means as is commonly done in the prior art. By appropriately controlling the operation of motors a desired profile of the grinding wheel may be generated by the dressing roll 10 as described herein below.

Components of the system 100 are shown in FIGS. 1A and 1B as single elements. Such illustration is for ease of description and it should be recognized that the system 100 may include multiple additional devices and components including embodiments of the system with multiple dressing rolls 10 and/or grinding wheels 20.

The present disclosure includes a rotary form dressing roll 10 for spiral-bevel and hypoid tooth grinding. Techniques described herein below include dressing all or substantially all of a grinding wheel profile, i.e., portions of the profile defined as a tip, an inside concave flank, and an outside convex flank, with a single dressing roll having one or more forms. Further, techniques described herein include plunge dressing with a single rotary form dressing roll 10 which utilizes line contact to create the entire grinding wheel profile, i.e., the tip and both flanks, including shoulder radii. The teachings herein may be used instead of conventional rotary dressing rolls which utilize point contact. The word “plunge” is used to mean any one of moving the dressing roll 10 into the grinding wheel 20, moving the grinding wheel 20 into the dressing roll 10, or moving both the grinding wheel 20 and the dressing roll 10 into one another to make a cut or to grind.

The dressing roll 10, can be formed per typical materials and processes, e.g. a steel or other material body, reverse- or positive-placement, sintered or (electro-) plated, using a hard abrasive material, e.g. diamond grit or diamond material pieces; i.e. using typical rotary dressing roll manufacturing methods in industry. The primary advantage of the disclosure is a significant cycle time reduction by plunge dressing rather than point contact along a profile. Various embodiments can include a more even dressing roll wear (i.e., a consistent material wear along a profile), longer dressing roll life, higher process consistency, faster initial dressing of a new grinding wheel, and the ability to use different diamond (or other abrasive) characteristics for dressing the concave versus the convex surfaces of the grinding wheel profile on the grinding wheel 20.

In some embodiments, compared with known point contact dressing techniques, taught herein can include higher power and torque consumptions on a dresser motor. Some embodiments require dedicated or custom dressing rolls for each part type or commonized part family. Some embodiments have a limited ability to control the dressing ratio as a function of tooth height, and limited profile adjustability, e.g. to profile crowning, tip radius, and shoulder radius. Depending on the particular hardware requirements, these requirements can be inconsequential, for example, in high-volume (e.g. automotive) production. Some embodiments may be utilized with various process parameters, diamond characteristic selection, etc. during the process development procedure prior to putting a ground tooth spiral-bevel gearset into production.

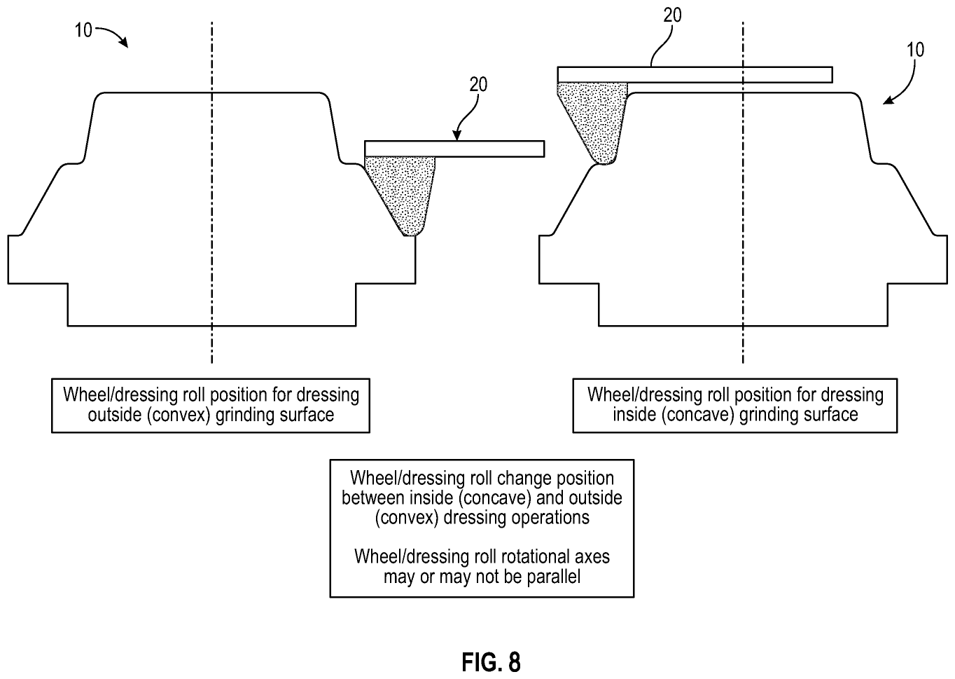

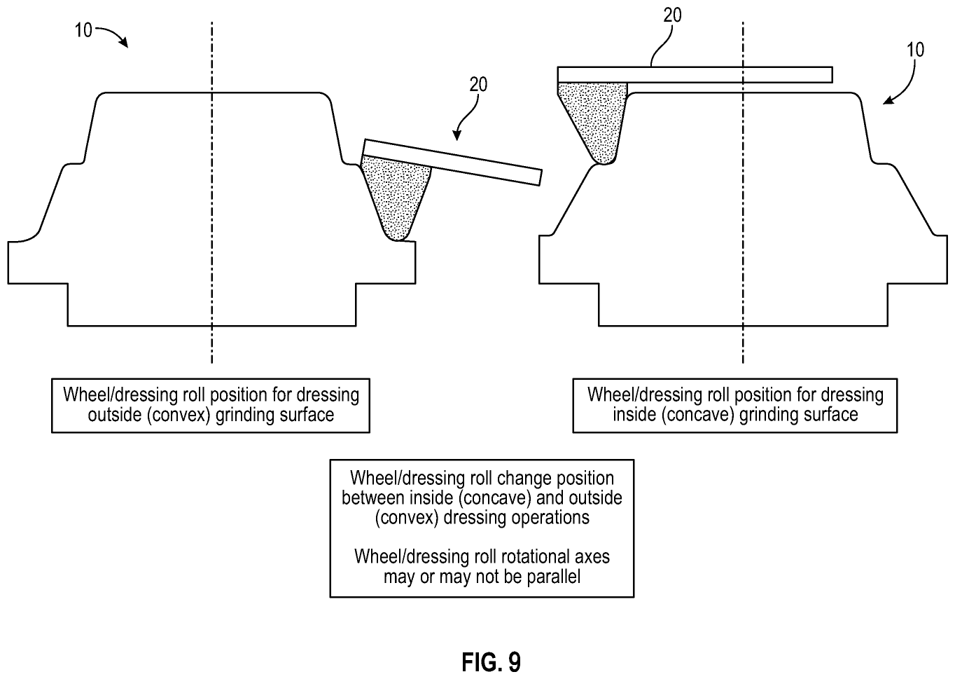

Embodiments of the present disclosure may be adapted for use on both so-called “vertical” and so-called “horizontal” designed spiral-bevel grinding machines. Vertical spiral-bevel grinders generally present the grinding wheel in an “upside-down” orientation, that is, facing downward. Dressing a grinding wheel on vertical grinders is generally performed with the dressing roll axis of rotation parallel or near-parallel to the grinding wheel axis of rotation. The present disclosure, when applied to vertical grinders, dresses the grinding wheel 20 with two positionings of the dressing roll 10: one for the tip and inside (concave) grinding wheel surface, and a second for the tip and outside (convex) grinding wheel surface (see FIGS. 8 and 9).

As FIG. 8 shows, the dressing roll 10 and the grinding wheel 20 are moved together so that line contact is made between a portion of the radial extent of the dressing roll 10 and a convex surface of the grinding wheel 20. After grinding the convex surface, the system releases the plunge and moves the dressing roll 10 and grinding wheel 20 together so that line contact is made between a portion of the radial extent of the dressing roll 10 and a concave surface of the grinding wheel 20. The dressing roll 10 and the grinding wheel 20 are rotated at a substantially identical axial plane. One skilled in the art, upon a careful reading of the teachings here will readily recognize that the rotation of the dressing roll 10 and the grinding wheel 20 may be altered at various axial planes of rotation depending, in part, on the profile on the dressing roll 10. For example, within a 0-degree to 20-degree range with respect to the axial planes of rotation during plunge dressing of the convex grinding wheel surface is conceived by the disclosure herein. As FIG. 9 shows, the grinding wheel 20 is tilted with respect to the axis of rotation of the dressing roll 10. Upon release of the plunge, the grinding wheel 20 is moved so that the axis of rotation is substantially parallel with the dressing roll 10, before making the second plunge dressing.

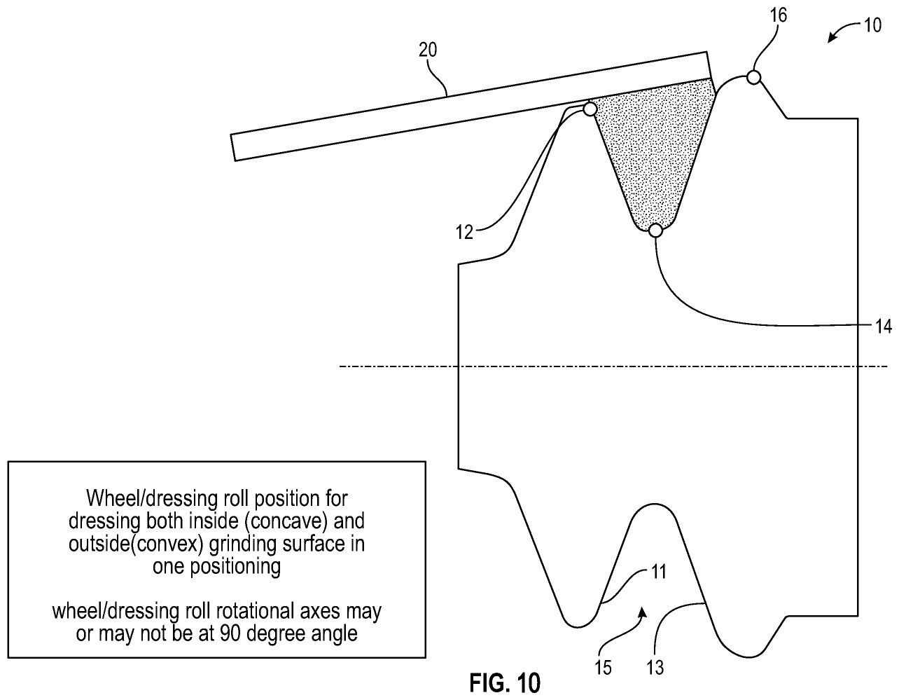

Horizontal spiral-bevel grinders generally present the grinding wheel 20 in a horizontal orientation, e.g. facing to the right (or left) when viewed from the operator position in front of the grinding machine. Dressing a grinding wheel 20 on horizontal grinders is generally done with the dressing roll 10 having an axis of rotation at a roughly right angle to the grinding wheel's 20 axis of rotation. The present disclosure, when applied to horizontal grinders, can dress the grinding wheel with one or two positionings of the dressing roll (see FIGS. 10, 11, 12, 13, 14 and 15). A single positioning of the dressing roll is preferred for maximum cycle time reduction, but two positionings may be required for some grinding wheel profile geometry requirements or for a preference of greater adjustability of the grinding wheel tooth thickness or pressure angle.

In some embodiments, horizontal grinders could move their translational and rotational axes to dress the grinding wheel 20 with the dressing roll's 10 axis of rotation parallel or near-parallel to the grinding wheel axis of rotation, similar to vertical grinding dressing, though this is uncommon in practice. In this event, the dressing operation would be similar to the embodiments depicted in FIGS. 8 and 9.

So-called “Horizontal” grinders, such as shown in exemplary FIG. 1B, variously have angular ranges for dresser positioning of approximately 0 to 95 degrees relative to the grinding wheel. It is contemplated that various embodiments can use one or more angular positions within this range for dressing roll tilt angles. Certain unusual or extreme angular positions may be valuable due to collision avoidance, minimization of machine movements, ease of dressing roll manufacture, or other considerations. However, given typical grinding wheel profile geometries in use, some angular tilt ranges will likely be typical. For a single positioning dressing roll on a horizontal grinder, the angular range will typically fall in a range from 60 to 95 degrees. For a two-positioning dressing roll on a horizontal grinder, the angular range for the outside convex grinding wheel surface will typically fall in a range from 80 to 90 degrees, or 0 to 20 degrees. For a two positioning dressing roll on a horizontal grinder, the angular range for the inside concave grinding wheel surface will typically fall in a range from 60 to 95 degrees, or 0 to 20 degrees.

So-called “Vertical” grinders, such as shown in exemplary FIG. 1A, variously have angular ranges for dresser positioning of approximately 0 to 95 degrees relative to the grinding wheel, but with a high risk of machine collision for dresser positioning values above 20 degrees. It is contemplated that various embodiments can use one or more angular positions within this range for dressing roll tilt angles. Certain unusual positions may be valuable due to collision avoidance, minimization of machine movements, ease of dressing roll manufacture, or other considerations. However, given typical grinding wheel profile geometries in use, some angular tilt ranges will likely be typical. For a two-positioning dressing roll on a vertical grinder, the angular range for the outside convex grinding wheel surface will typically fall in a range from 0 to 20 degrees. For a two-positioning dressing roll on a vertical grinder, the angular range for the inside concave grinding wheel surface will typically fall in a range from 0 to 20 degrees.

As FIG. 10 shows, a single circumferential channel 15 may be used to plunge dress both a convex surface of the grinding wheel and a concave surface of the grinding wheel 20 simultaneously. As FIG. 10 shows, exemplary radial extent points 12 and 14 of the dressing roll 10 may define a concave surface 11 of the grinding wheel 20, while radial extent points 14 and 16 define a convex surface 13 of the grinding wheel 20. In various embodiments, the first cutting surface 11 has an S-shaped, in cross sectional, configured for line of contact with the grinding wheel 20, and a second cutting surface 13 having an oppositely aligned (i.e., backward ‘S’ shape), with respect to the first cutting surface shape, in cross-sectional, for line of contact. In operation, the circumferential channel 15, having a first side portion 13 for contacting the convex surface of the grinder and a second side portion 11 for contacting the concave surface of the grinder, makes the plunge dress cut, simultaneously cutting both surfaces of the grinding wheel 20. In various embodiments, the dressing roll 10 and the grinding wheel 20 rotate within a 60-degree to 95-degree range with respect to the axial planes of rotation during plunge dressing of both the concave and convex grinding wheel surfaces.

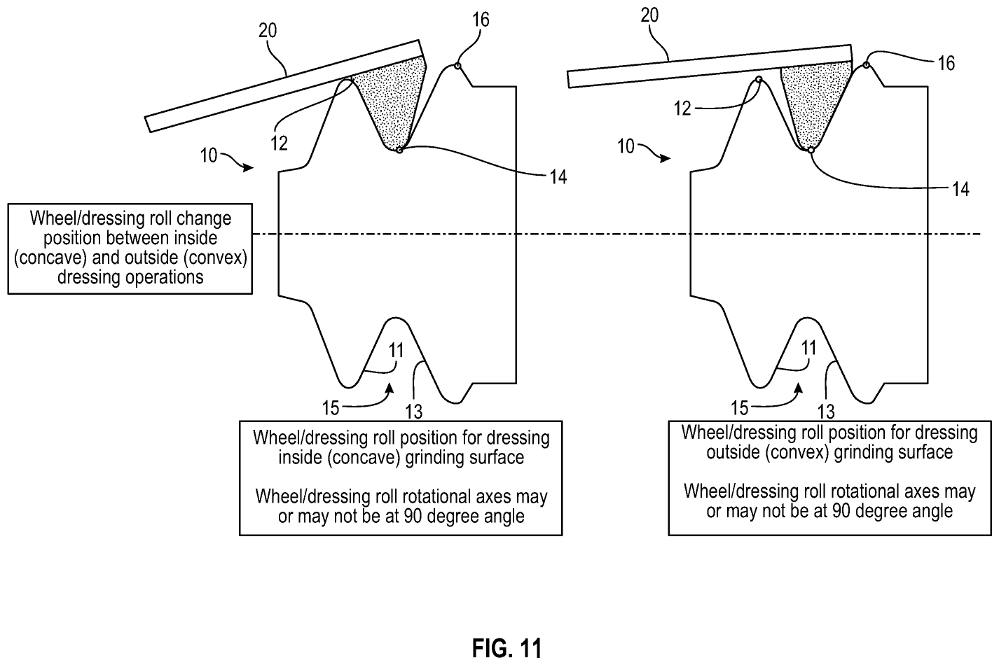

As FIG. 11 shows, the single circumferential channel 15 may be used to plunge dress a first surface of the grinder wheel 20 and then the other surface by having the dressing roll 10 and the grinding wheel 20 tilt from a first position to a second position with respect to one another. It is contemplated by the disclosure herein that the tilting can be done by one or the other of the dressing roll 10 and the grinding wheel 20 or both simultaneously. In one embodiment, the tilting is made within an 80-degree to 90-degree range with respect to the axial planes of rotation during plunge dressing of the convex grinding wheel surface, and rotate the dressing roll and the grinding wheel within a 60-degree to 95-degree range with respect to the axial planes of rotation during plunge dressing of the concave grinding wheel surface. In one embodiment, the tilting is made within a 60-degree to 95-degree range with respect to the axial planes of rotation during plunge dressing of the convex grinding wheel surface, and rotate the dressing roll and the grinding wheel within a 60-degree to 95-degree range with respect to the axial planes of rotation during plunge dressing of the concave grinding wheel surface. “Tilting” as used herein, refers to the change of axial planes of rotation between the grinding wheel 20 and the dressing roll 10. For example, after plunge dressing the concave surface of the grinding wheel, the grinding wheel may be tilted before plunge dressing the convex surface of the grinding wheel.

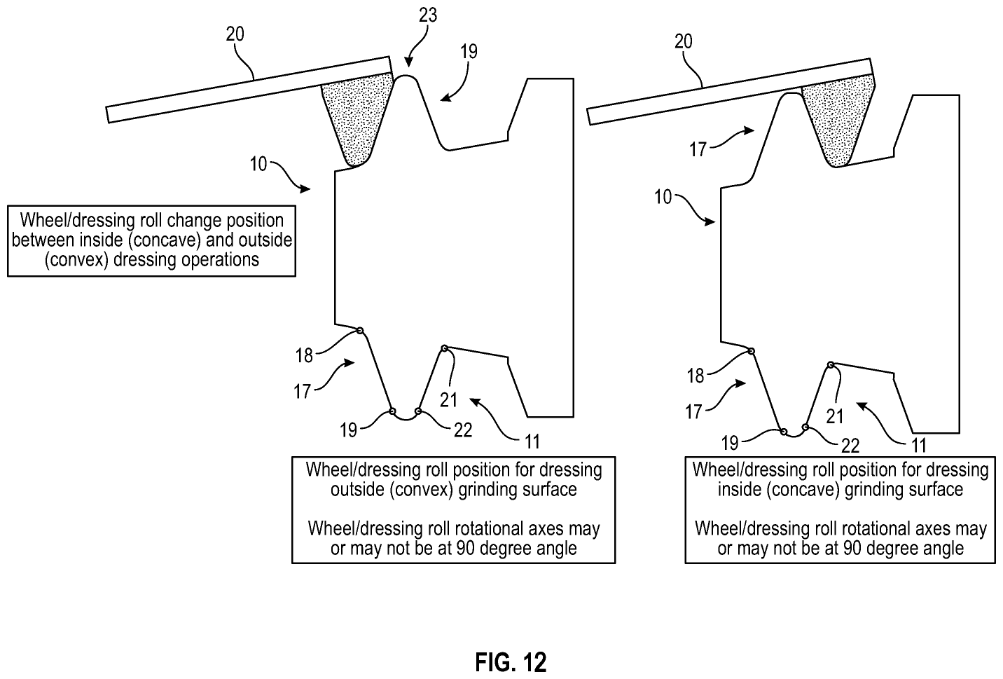

FIG. 12 shows an exemplary embodiment of a plunge dressing wherein the dressing roll and grinding wheel are rotated at substantially a 90-degree axial plane. The dressing roll and grinding wheel are moved together so that line contact is made between a portion of the radial extent 17 of the dressing roll 10 and a convex surface of the grinding wheel 20. After releasing the plunge, the dressing roll 10 and grinding wheel 20 are again moved together so that line contact is made between a portion of the radial extent 19 of the dressing roll 10 and a concave surface of the grinding wheel 20. In one embodiment, the dressing roll includes a circumferential protrusion 23 having a first side portion 17 for contacting a convex surface of the grinding wheel 20 and a second side portion 11 for contacting a concave surface of the grinding wheel 20. As FIG. 12 shows, the first side portion 17 may be defined between radial extent points 18 and 19, while the second side portion 11 may be defined between radial extent points 21 and 22. In various embodiments, radial extent points 19 and 22 may define a portion that is included within the first side portion 17 and/or the second side portion 19. While radial extent points 18 and 21 are shown in FIG. 12 in exemplary positions, it is to be understood that the points 18 and 21 may be further from points 19 and 22, respectively, or closer, so that a desirable radius is included in the plunge cut, in various embodiments. While the rotational axis of the dressing roll 10 and the grinding wheel 20 may be substantially perpendicular, it is contemplated herein that the axis of rotation may range from an 0-degree to 95-degree range with respect to the axial planes of rotation during plunge dressing of the convex grinding wheel surface, and rotate the dressing roll and the grinding wheel within a 0-degree to 95-degree range with respect to the axial planes of rotation during plunge dressing of the concave grinding wheel surface.

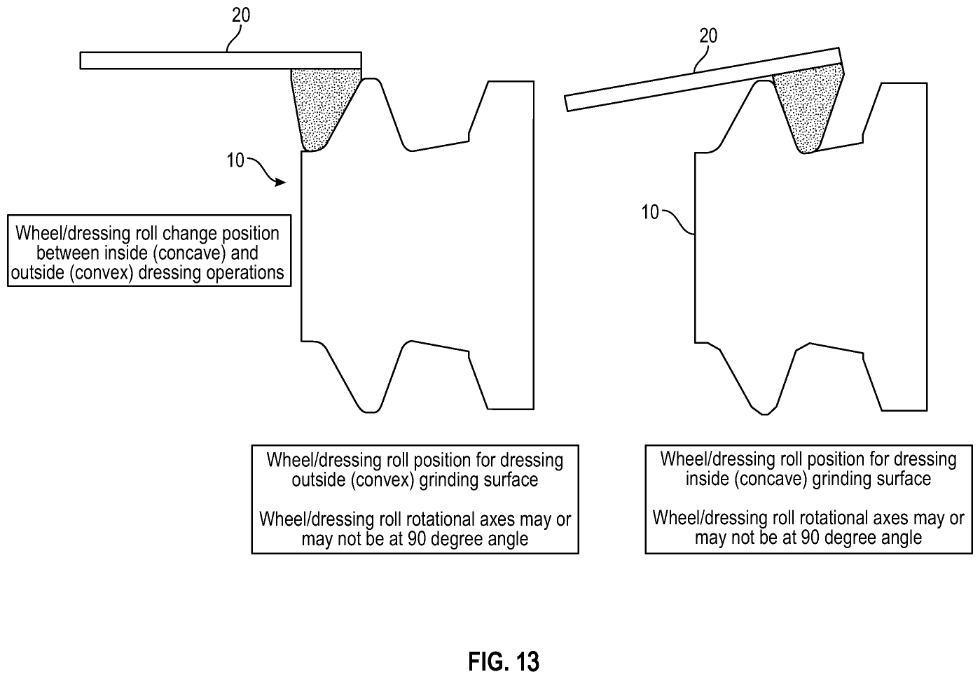

As FIG. 13 illustrates any tilting of either the dressing roll 10 or the grinding wheel 20 between plunge dressings may be executed by keeping the axial rotational angles within the 0-degree to 95-degree range with respect to one another.

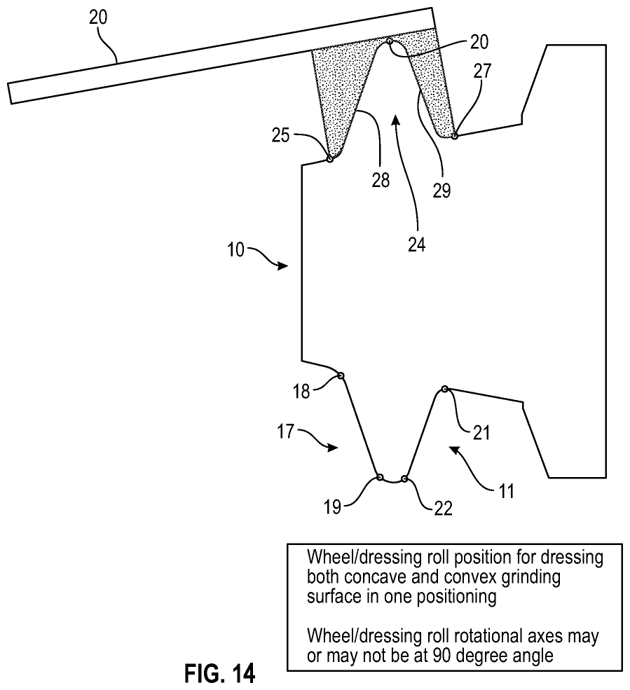

FIG. 14 shows an exemplary embodiment of a grinding wheel 20 having a circumferential channel 24, dressed by a dressing roll 10 having a protrusion 23. The circumferential channel 24 is defined by a first side portion 28 and a second side portion 29. The first side portion 28 may be defined by radial extent points 25 and 26, and the second side portion 29 may be defined by radial extent points 26 and 27, with respect to a center of the grinding wheel 20. The circumferential channel 24 may be dressed by a corresponding circumferential protrusion 23 of the dressing roll 10, which is preferably integral therewith. The circumferential protrusion 23 may include the first side portion 17 and the second side portion 11, and a tip portion defined by radial extent points 19 and 22. The circumferential protrusion 23 may be defined by exemplary radial extents 18, 19, 22, and 21. One skilled in the art will readily recognize, that the exemplary radial extents 18, 19, 22, and 21 positions may vary in various embodiments. In operation, the dressing roll 10 and grinding wheel 20 are moved together so that line contact, in cross-sectional, is made between the circumferential protrusion 23 of the dressing roll 10 and simultaneously on both side portions of a circumferential channel 24 of the grinding wheel 20. In various embodiments, the axial rotation planes of rotation may be substantially perpendicular. It is further contemplated that the dressing roll 10 and the grinding wheel 20 may be operated within a 0-degree to 95-degree range with respect to the respective axial planes.

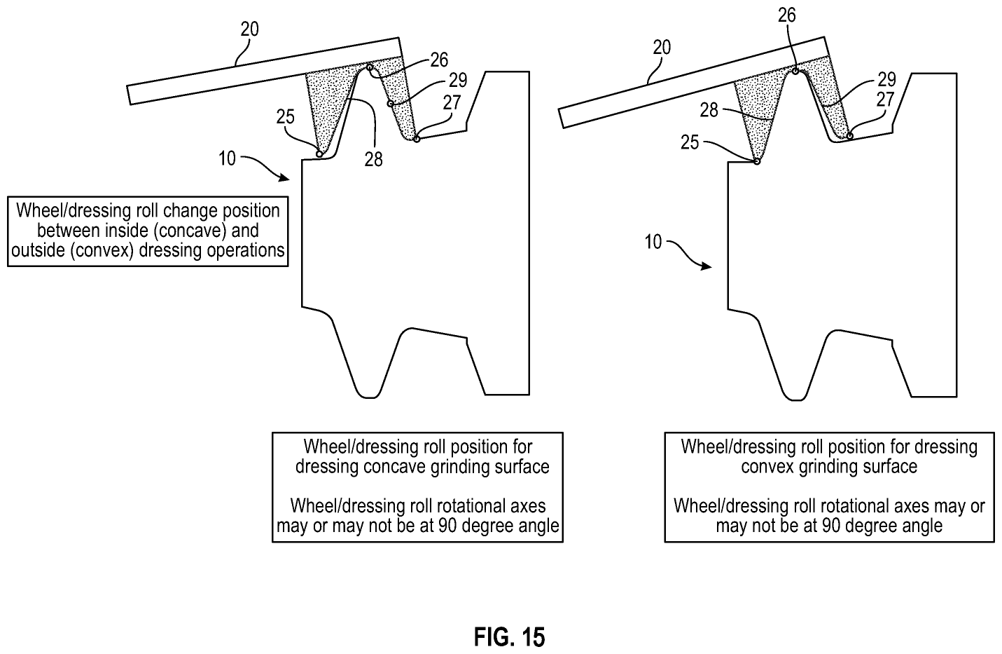

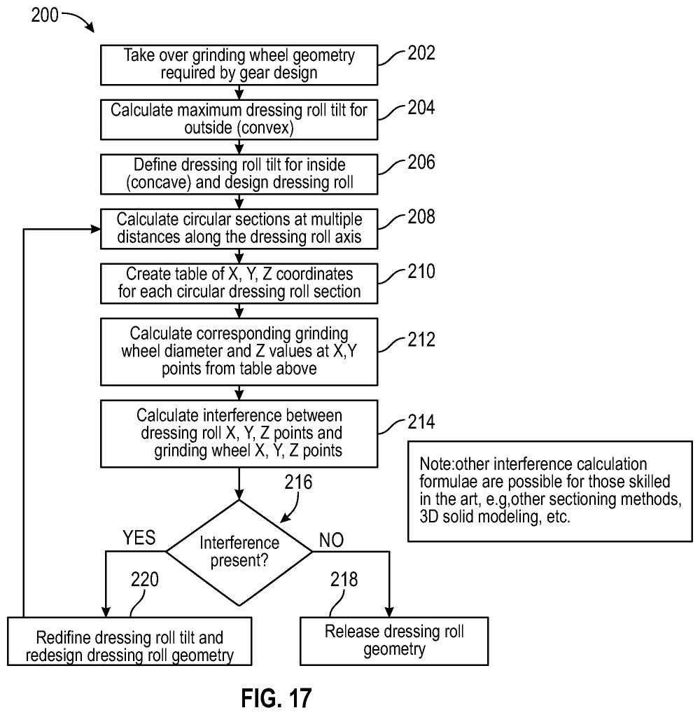

FIG. 15 shows another exemplary embodiment of a grinding wheel 20 having a circumferential channel 24, dressed by a dressing roll 10 having a protrusion 23. In operation, the dressing roll 10 and grinding wheel 20 are moved together so that line contact, in cross-sectional, is made between the first side portion 28 and then the second side portion 29 or vice versa, as shown in FIG. 17. The axial rotation planes may be substantially perpendicular. In some embodiments the dressing roll 10 and the grinding wheel 20 may be operated within a 0-degree to 95-degree range with respect to the respective axial planes.

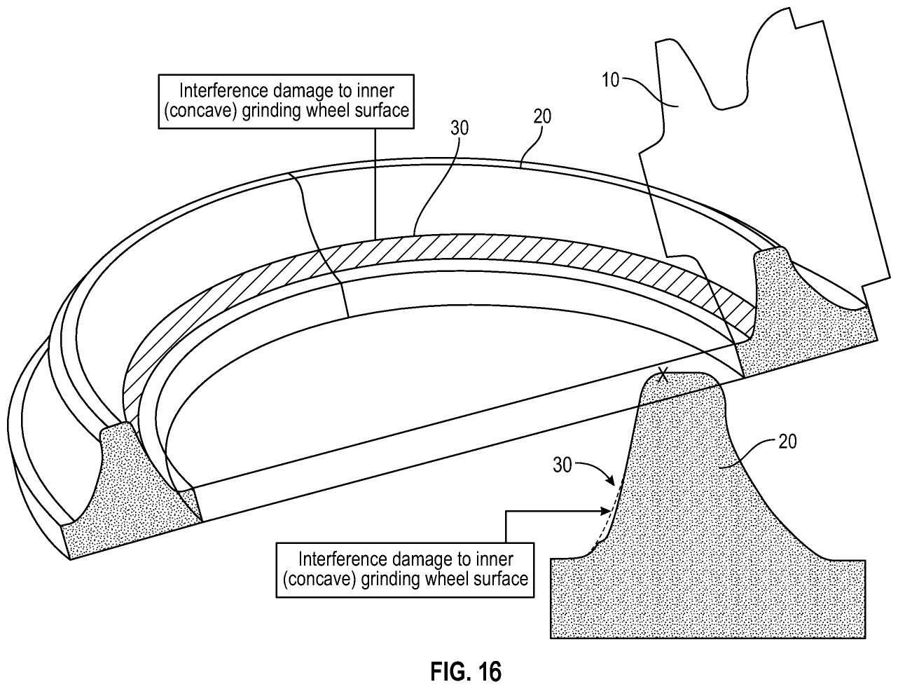

FIG. 16 is a cross-section view of the grinding wheel 20 depicting an exemplary area 30 where interference by the dressing roll 10 may occur. A roughly right angle dressing orientation presents a challenge when applying a rotary form dressing roll of the disclosure herein, due to a high risk of interference when dressing the inside (concave) grinding wheel surface. For example, when using a rotary form dressing roll of approximately 72 mm diameter and a grinding wheel of approximately 150 mm diameter (both being common dimensions used in spiral-bevel grinding) to dress inside (concave) grinding wheel surfaces with pressure angles below approximately 28 degrees (also common in spiral bevel grinding) the dressing roll will contact the inside (concave) grinding wheel 20 surface not only on the central line about the dressing roll axis of rotation, but also on the rim or other areas of the dressing roll as it enters the desired linear contact zone without proper orientation of the dressing roll 10. Contacting the grinding wheel 20 is known as interference and is highly undesirable. This interference contact will damage the inside (concave) surface of the grinding wheel 20, which can render it unusable.

In some embodiments, the outside (convex) grinding wheel surface can generally be dressed without dressing roll tilt and without the risk of interference. However, when dressing the inside (concave) surface portion of the grinding wheel 20 with dressing roll tilt, it may be desirable to use a dressing roll tilt angle for the outside (convex) grinding wheel surface. In this case, if the amount of dressing roll tilt is significant, and the outside (convex) grinding wheel surface has at least one section of the grinding wheel profile with a steep effective pressure angle (for example, if significant protuberance is designed on the outside (convex) grinding wheel surface in combination with a steep pressure angle and large amount of profile crowning), interference may occur on the outside (convex) grinding wheel surface as well. This interference contact will damage the outside (convex) surface of the grinding wheel, most often rendering it unusable.

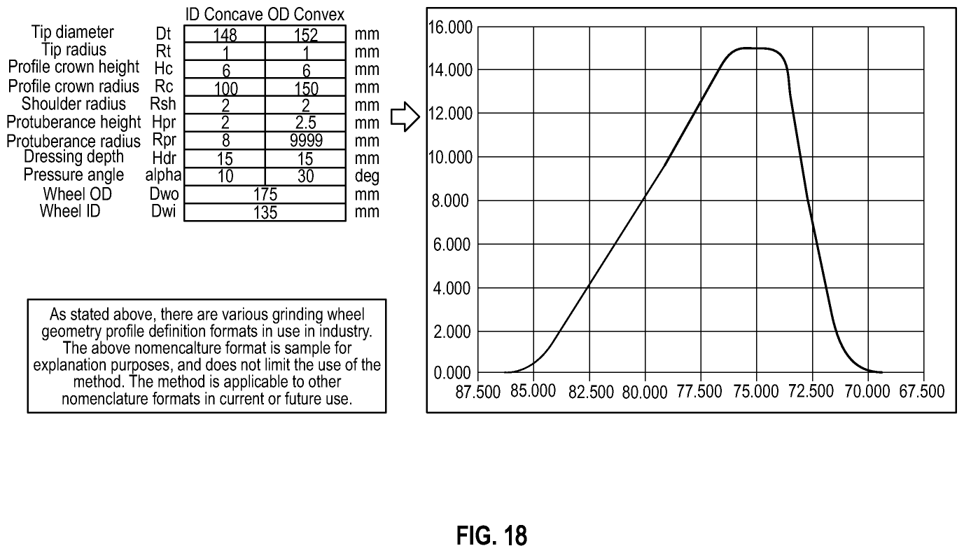

FIG. 17 shows an exemplary process 200 the system 100 can execute for determining whether interference will occur between the grinding wheel 20 and the dressing roll 10. Various embodiments of the system 100 utilizing form dressing the grinding wheel 20 may be benefited from determining the occurrence, location, and amount of the interference described above in order to determine whether or not to dress the grinding wheel 20 with a particular set of form dressing parameters. As FIG. 17 shows, the exemplary process is initiated at step 202 by receiving a grinding wheel profile specification defined by the gear design to calculate a complete grinding profile (see FIG. 18). At step 204, the system 100 then calculates the minimum effective angle of the outside (convex) grinding wheel surface, which can be used to determine the maximum dressing roll tilt that can be used without interference on the outside (convex) grinding wheel surface. At step 206, dressing roll tilt for inside (concave) grinding wheel surface may be defined based upon the grinding wheel profile and the dressing roll. In some embodiments, the “side shift”, i.e. positioning the dressing roll 10 for contact with the grinding wheel 20, if any, may be included in the operating parameters. In practice, it may be desirable to limit the dressing roll tilt to provide a minimum angle between the dressing roll tilt angle and the minimum effective angle of the outside (convex) grinding wheel surface, in order to even out dressing roll wear and improve dressing roll tool life.

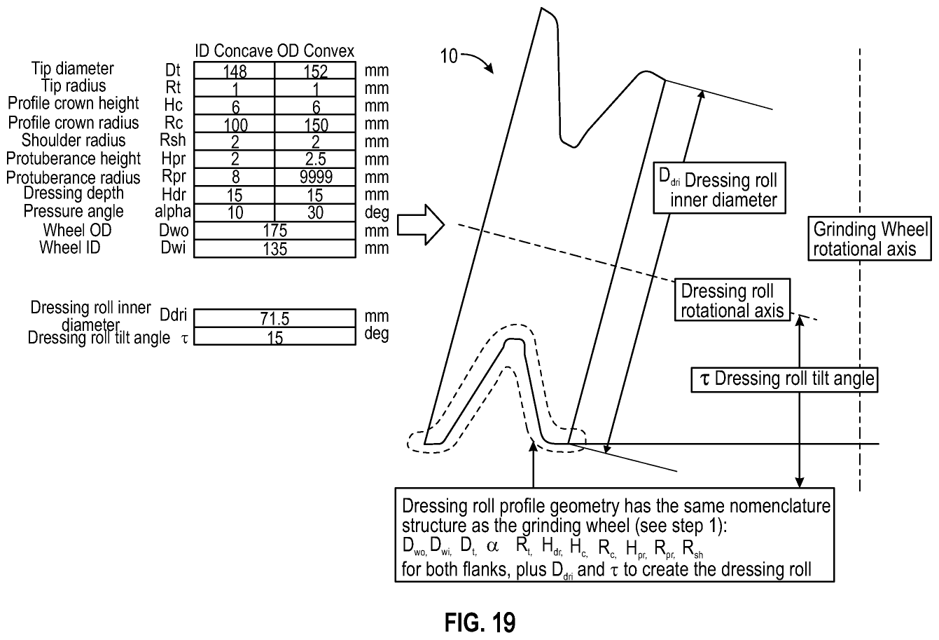

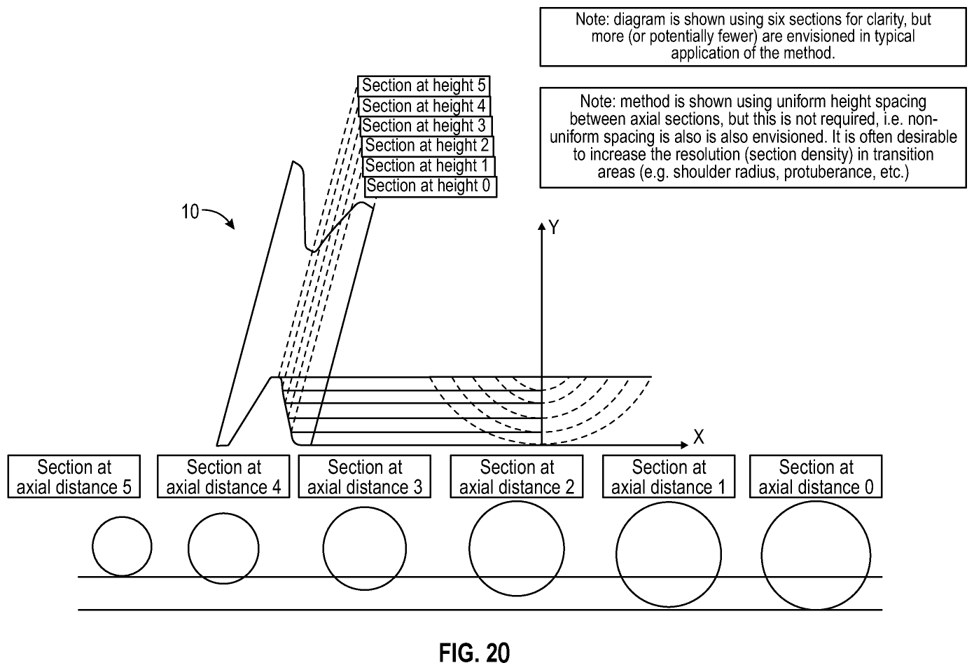

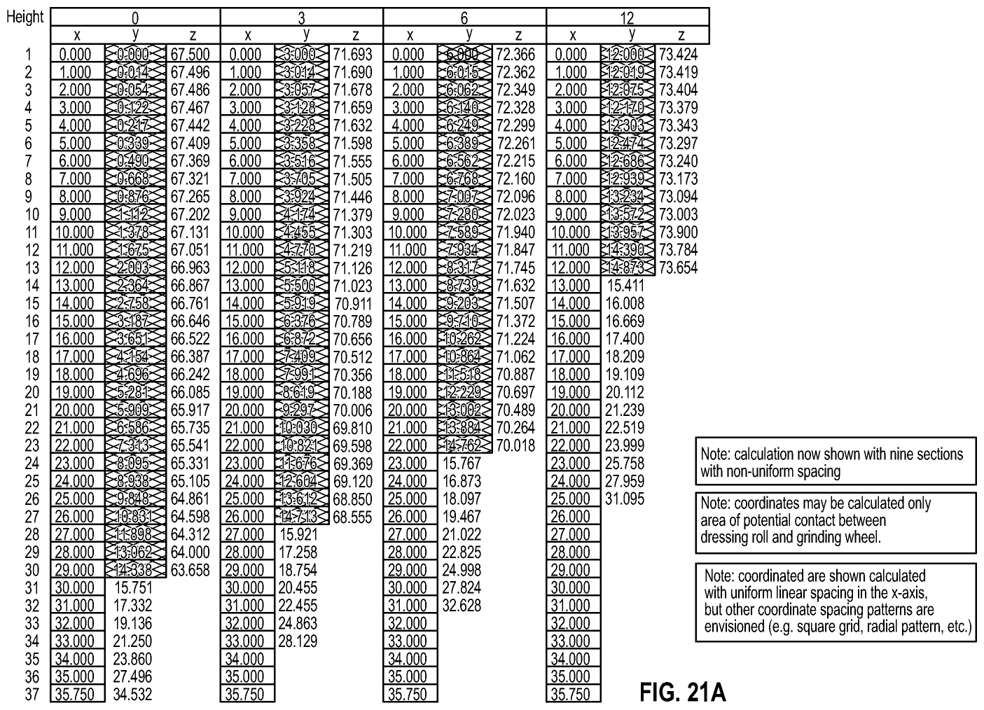

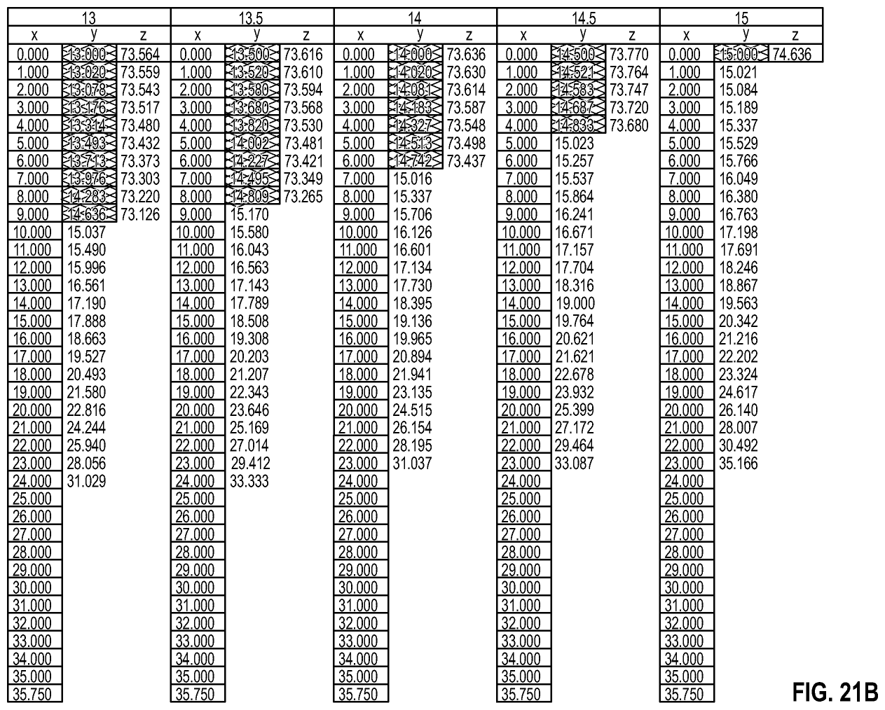

The system 100 receives initial inputs to define the dressing roll geometry, which can include the dressing roll inner diameter and the tilt angle. The system 100 can now generate the active surfaces of the initial dressing roll geometry (FIG. 19). At step 208, for the inside (concave) grinding wheel surface, the system 100 calculates circular curves at multiple points along the height of the grinding wheel profile, based on the dressing roll geometry and selected dressing roll tilt angle (FIG. 20).

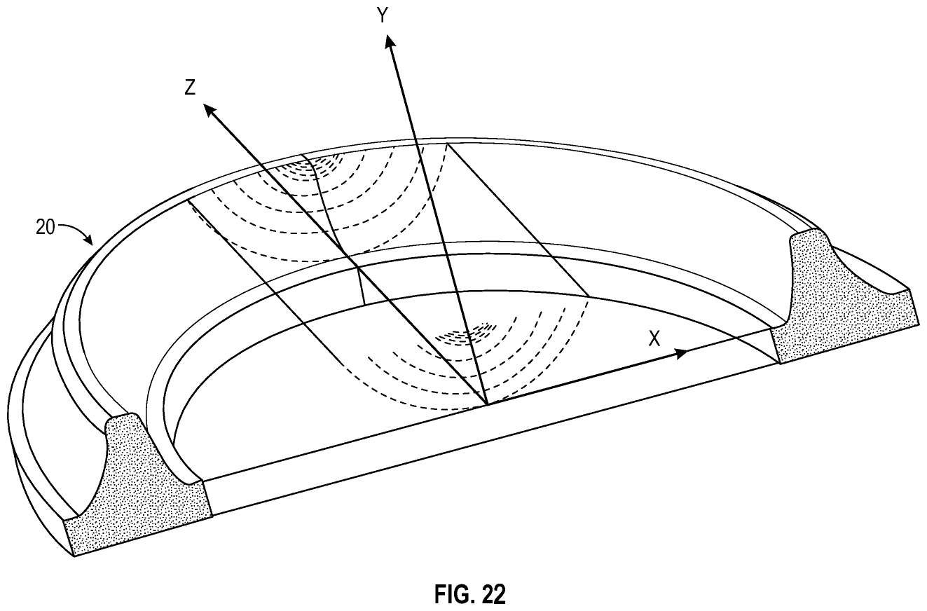

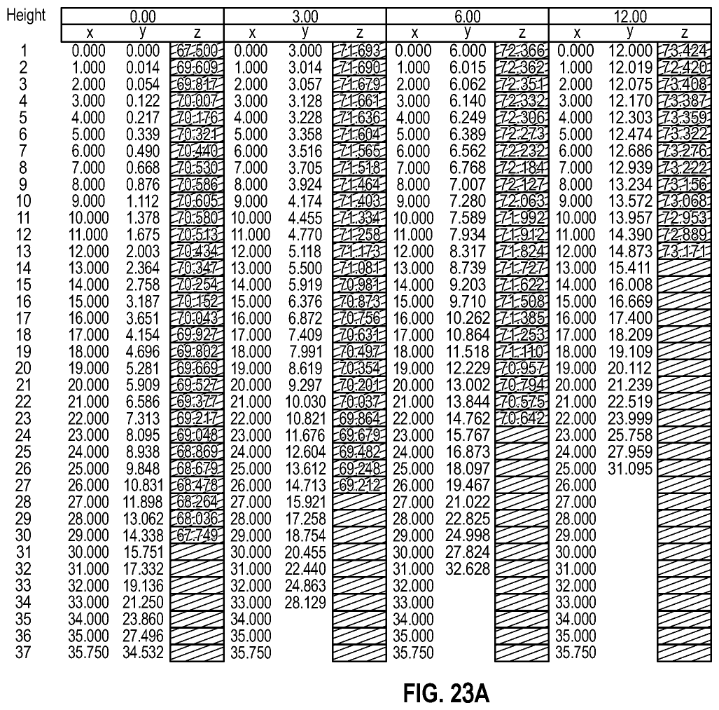

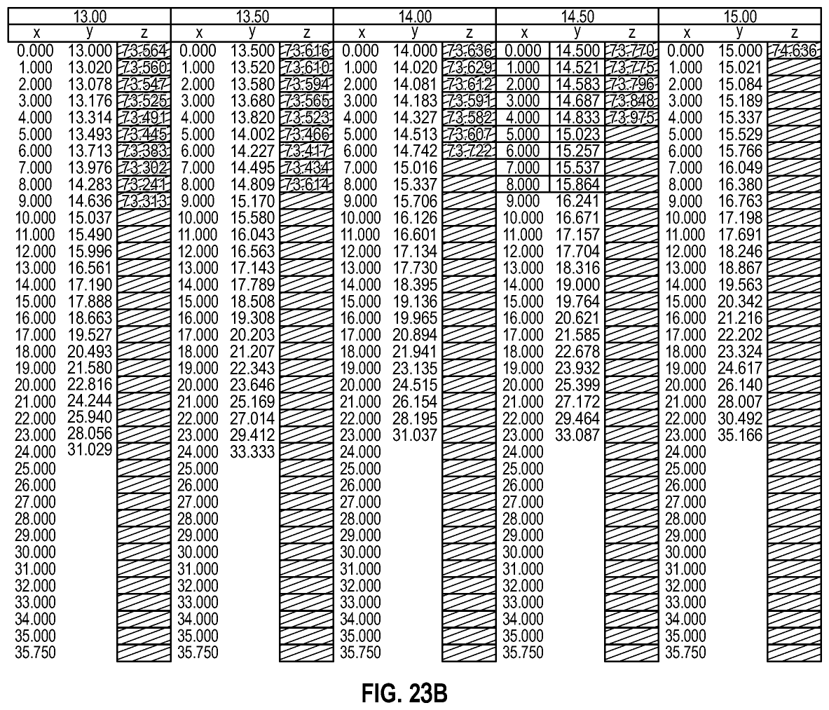

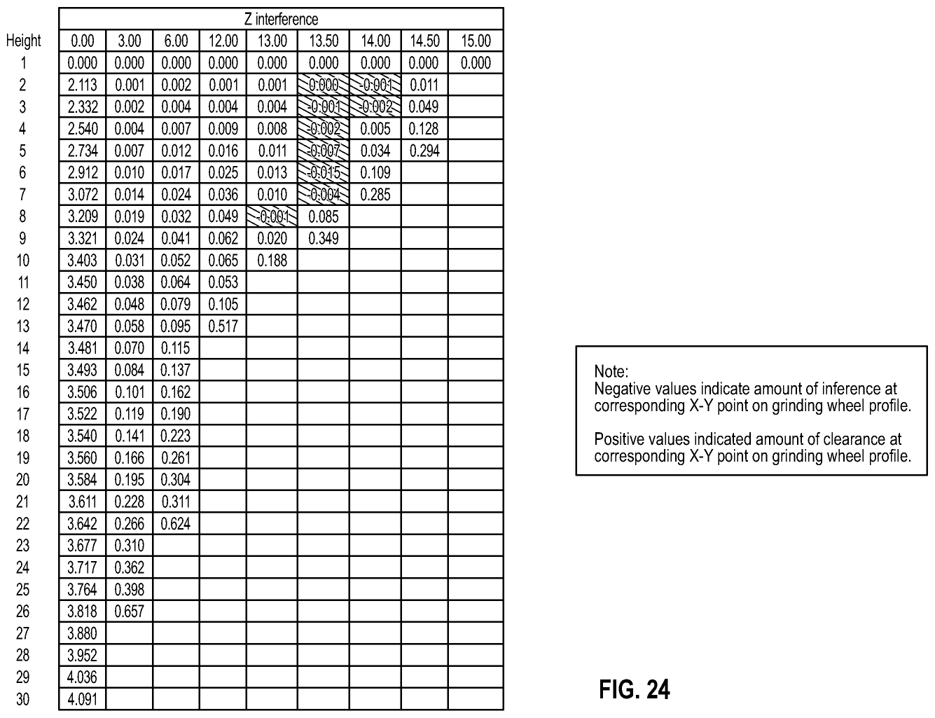

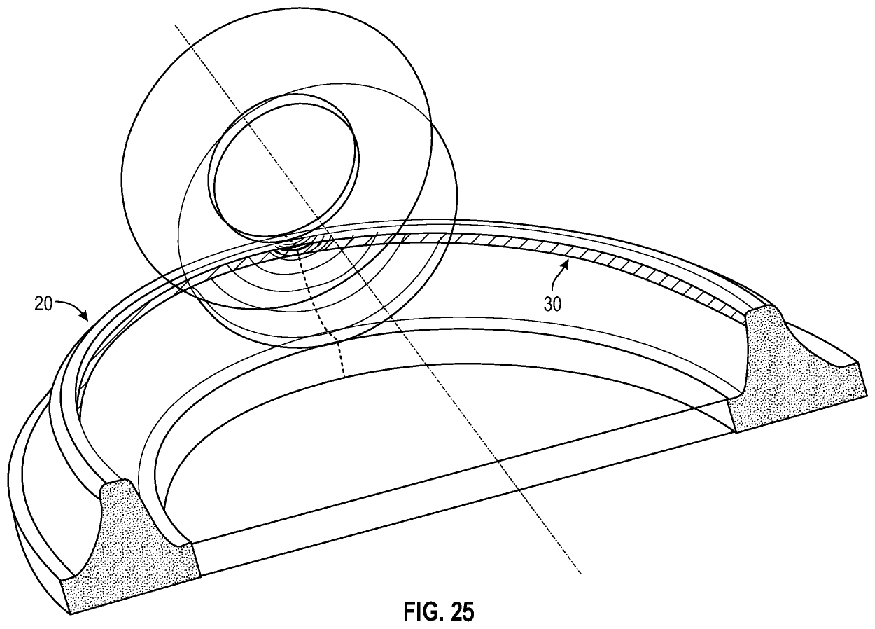

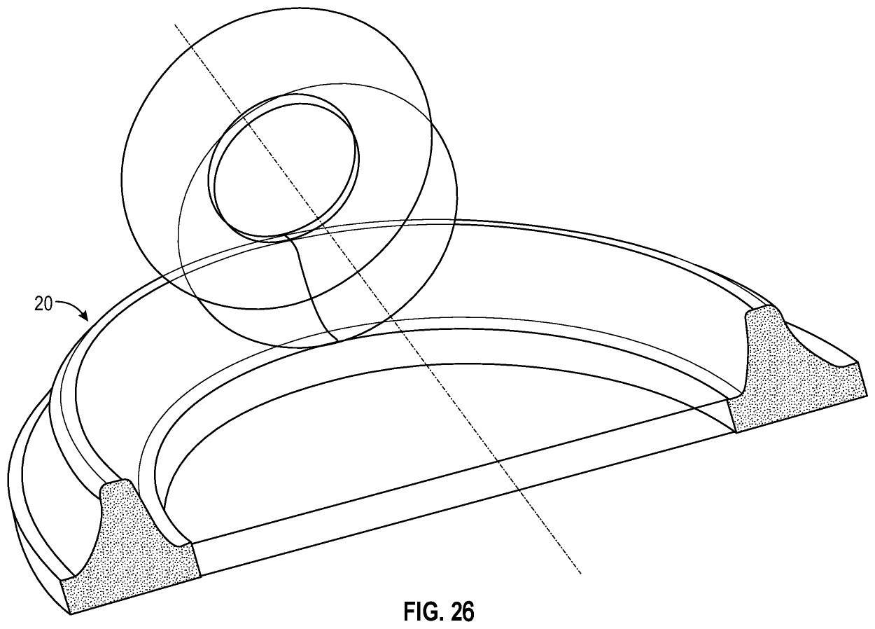

At step 210, the system 100 then calculates corresponding points on circular curves created by sections of the dressing roll at these X, Y, and Z points along the height of the grinding wheel. At step 212, the system 100 can calculate corresponding grinding wheel diameter and Z values at X and Y points for each circular section based on the grinding wheel profile geometry (FIG. 22), which can be stored in a table (see e.g., FIG. 23) for each circular section. At step 214, the system 100 then calculates the difference between the points on these curves in the widths of potential contact between the grinding wheel and the dressing roll at the particular points along the height of the grinding wheel, giving the clearance distance or flagging any interference between the curves which can be stored in a table (see e.g., FIG. 24). At step 216, the system 100 may inquire whether interference is present. If interference is present on the inside (concave) grinding wheel surface (see e.g., FIG. 25), the dressing roll geometry and tilt angle can be modified (step 220) and the calculation rerun, until the calculation result is free from interference or achieves the desired clearance (FIG. 26), in which case the calculated dressing roll geometry is released for use (step 218).

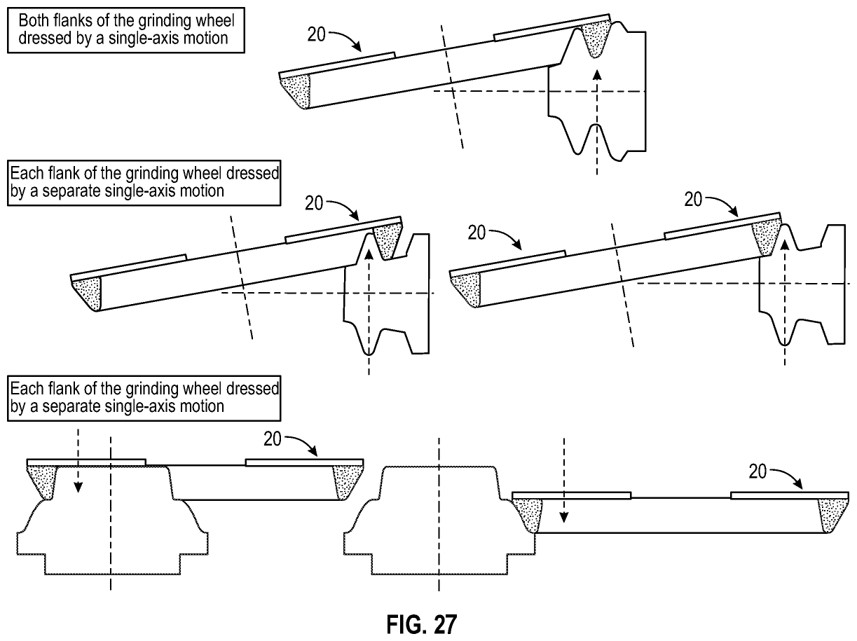

The outside (convex) grinding wheel surface can generally be dressed without dressing roll tilt, as may be selected based on dressing roll geometry, relative curvature considerations, and risk of collision with other areas internal to the spiral-bevel grinding machine (e.g. workpiece, tailstock, coolant pipes, etc.). Selection of dressing roll geometry and tilt angle, in conjunction with the grinding wheel profile geometry defined by the gear design, may allow a “single axis” dressing motion (FIG. 27), where the dressing movement itself can be carried out by a controlled movement of a single-axis of the spiral-bevel grinding machine (ignoring the high-speed rotation of the grinding wheel and dressing roll axes), rather than the combined simultaneous movement of two or more axes. This is a significantly easier task from the perspective of CNC motion control, with resulting increased accuracy of the dressed grinding wheel profile.

In various embodiments, selection of dressing roll geometry and tilt angles, in conjunction with the grinding wheel profile geometry defined by the gear design, may allow the angle between the grinding wheel and the dressing roll axis to be 90 degrees when dressing one or both flanks of the grinding wheel, which may be desirable, e.g. for machine collision avoidance purposes during automated part loading and unloading.

In various embodiments, selection of dressing roll geometry and tilt angles, in conjunction with the grinding wheel profile geometry defined by the gear design, may allow the angle between the grinding wheel and the dressing roll axis to be 0-degrees when dressing one or both flanks of the grinding wheel, which may be desirable, e.g. for machine collision avoidance purposes during automated part loading and unloading.

In some embodiments, at step 208, the system 100 can assess the desired torque and power required for plunge dressing. Without assessing the torque and power requirements, the capacity of the dressing unit of the grinding machine could be exceeded. In order to facilitate the application of plunge dressing, it is useful to have an estimate of the torque and power required. This requirement variously depends on multiple parameters, including the type of grinding wheel being dressed (e.g. bond strength, porosity, etc.), the type of diamond on the dressing roll (e.g. shape, protrusion, density of application, etc.), the feed rate used for the plunge dressing (e.g. mm/minute or inches/minute), the dressing roll geometry and the speeds used for the plunge dressing (e.g. in rpm, both of the dressing roll and the grinding wheel). Factors can be calculated to estimate the effect of these parameters, and these factors used to generate a torque and power estimate for a given set of plunge dressing parameters. By comparing this estimate to a pre-determined limit for a given grinding machine dressing unit, it can be predicted whether a given plunge dressing process will be possible for a given dressing unit. In such cases as the torque and power requirements exceed the capacity of the dressing unit, the process parameters (e.g. feed rate) can be reduced until the dressing unit exceeds the torque and power requirements of the plunge dressing process.

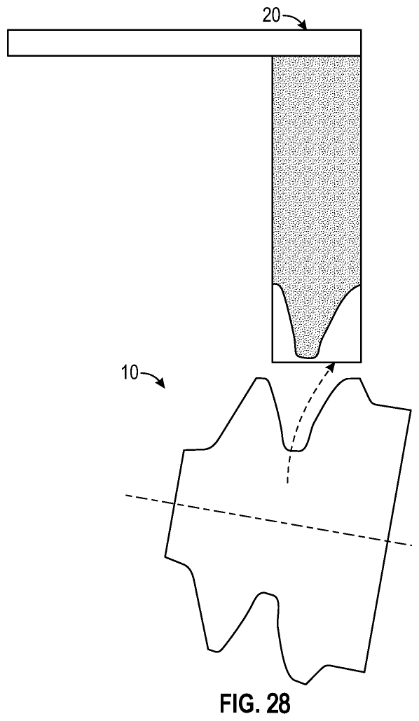

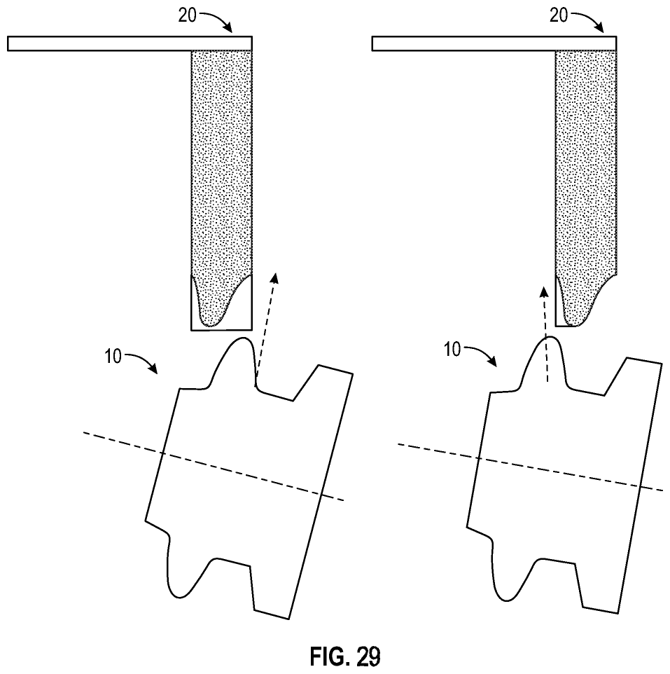

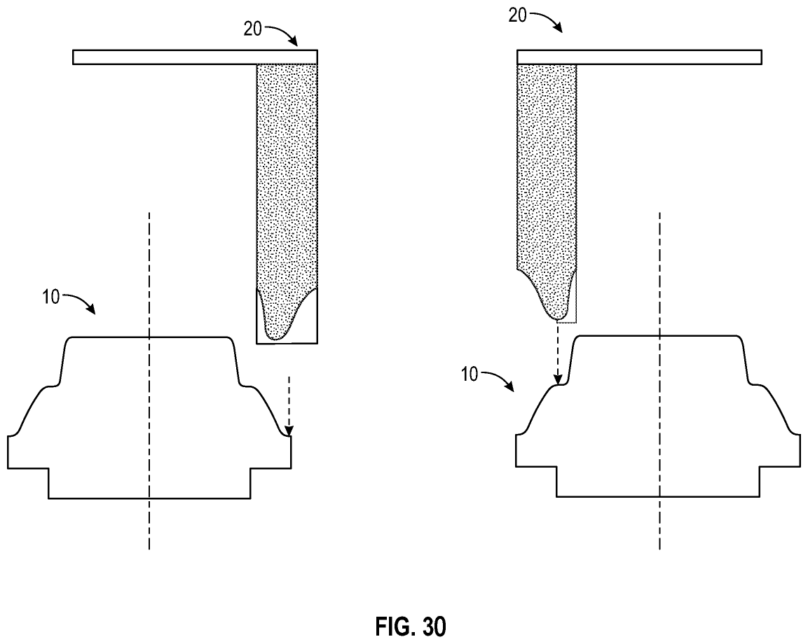

An additional novel application of the present disclosure is an improved feeding technique for initial dressing of a new grinding wheel (FIGS. 28, 29 and 30). New grinding wheels can be dressed in fewer passes without risk of consequential dressing roll wear, as the non-critical external rim of the dressing roll bears the brunt of the grinding wheel material removal. This can reduce the cycle time for initial dressing of a new grinding wheel, which can take 20-45 minutes, significantly, as well as reduce the amount of care that must be taken by a machine operator to ensure that the grinding wheel has been fully dressed.

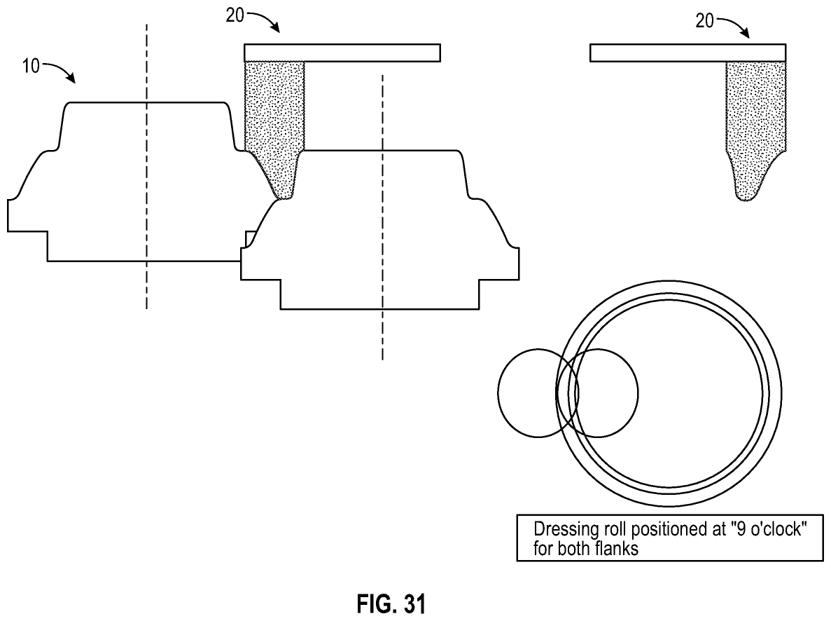

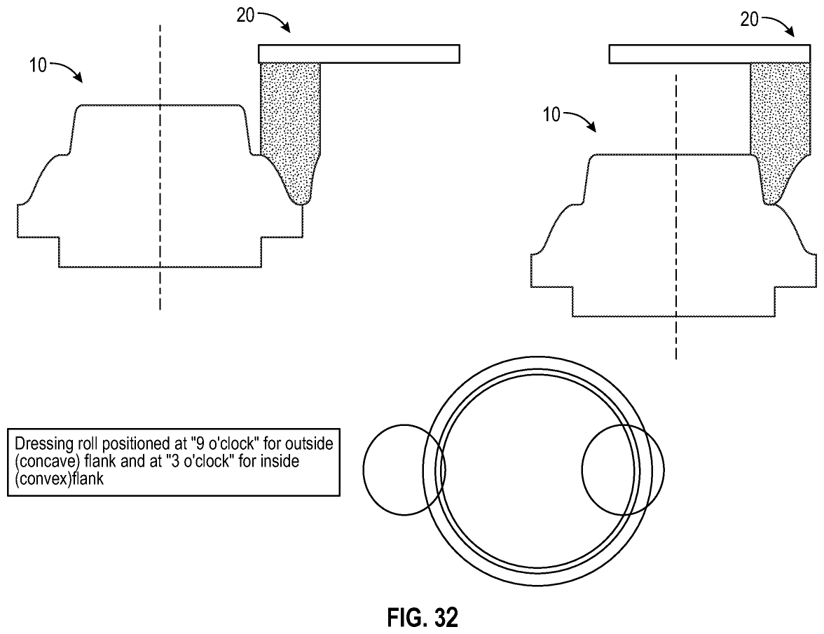

It is an understanding that the rotary form dressing roll of the current disclosure could be applied to the grinding wheel surfaces at different positions when viewing the grinding wheel “face on”, for example to avoid a machine collision or undesirable interference. For example, the inside (concave) grinding wheel surface could be dressed by applying the invented rotary form dressing roll 10 to the grinding wheel 20 at the “3 o'clock” position, and the outside (convex) grinding wheel 20 surface could be dressed by applying the disclosed rotary form dressing roll 10 to the grinding wheel 20 at the “9 o'clock” position, or vice versa (FIGS. 31 and 32). Other angular positions (e.g. “4 o'clock”) are also possible.

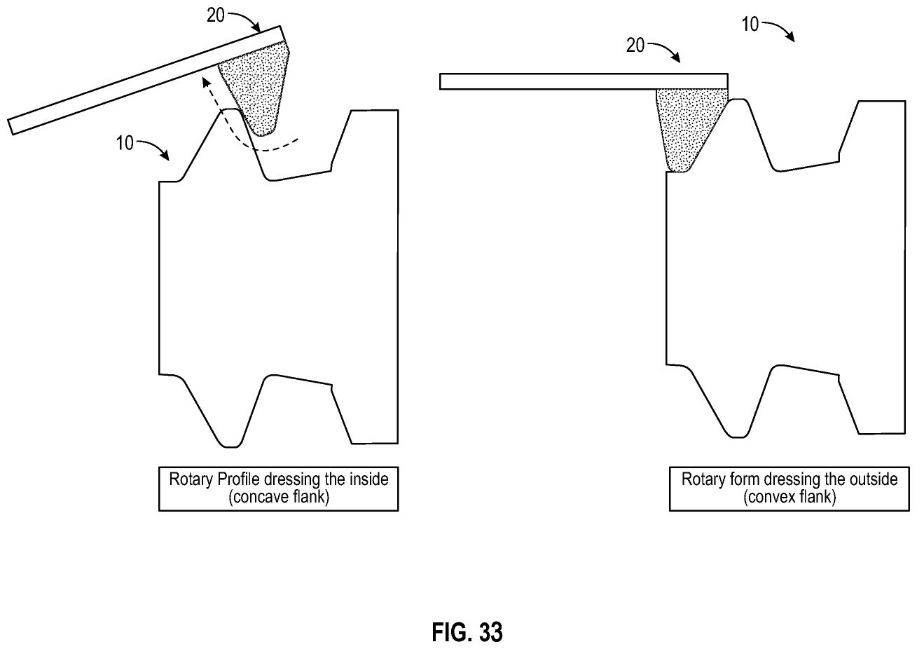

It is an understanding that the present disclosure could be used to form dress one flank of the grinding wheel 20 and profile dress the other flank of the grinding wheel 20 (FIG. 33). The cycle time improvement would be diminished, but this approach may be advantageous in some cases, for example to apply flank surface modifications not designed into an existing rotary form dressing roll of the present disclosure (e.g. a profile crowning modification).

It is a further understanding that the present disclosure could be used to profile dress both flanks of the grinding wheel 20. The cycle time improvement would be eliminated, but this approach may be advantageous in some cases, for example to apply flank surface modifications not designed into an existing rotary form dressing roll of the present invention (e.g. a profile crowning modification).

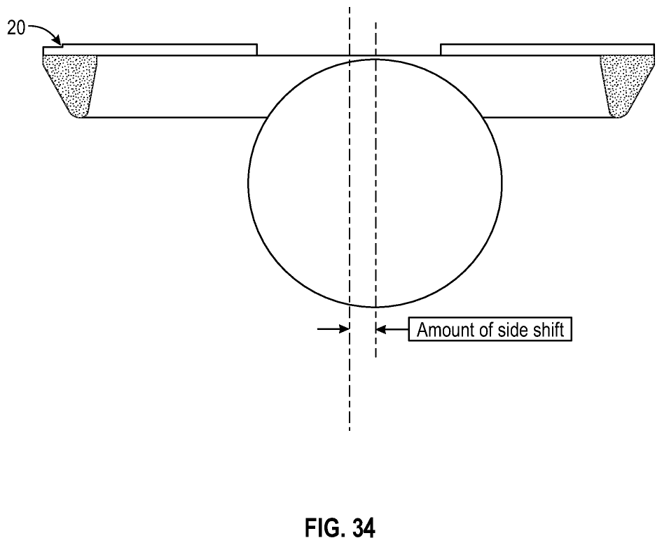

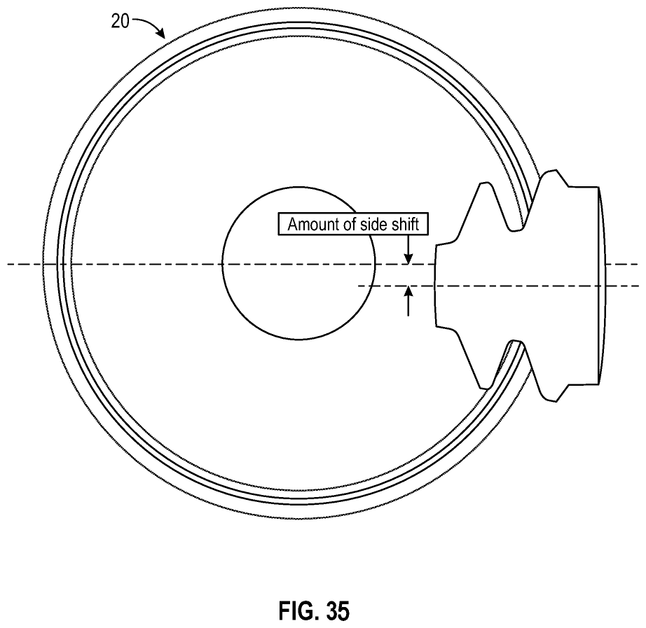

It is an understanding that the present disclosure could be used with “side shift”, i.e. positioning the dressing roll 10 for contact with the grinding wheel 20 along a chord as opposed to a radius, in order to make minor adjustments to the as-dressed pressure angles of one or both flanks of the grinding wheel (FIGS. 34 and 35). This shift can also be used in combination with modification to the tilt angle.

In various embodiments of the invention, it is advantageous that internal radii of a grinding wheel surface, such as a transition between a profile crowning curve and a protuberance curve, can be made with internal radii smaller than prior art rotary profile generating rolls. For example, a common rotary profile generating roll has a tip radius of ˜2.54 mm, which prevents the design of grinding wheel surfaces with internal radii less than ˜2.54 mm. Prior art rotary profile generating rolls with small tip radius values, e.g. 0.25 mm, suffer from rapid dressing roll facet wear and produce feed marks when dressing grinding wheel surfaces unless used with an excessively slow dressing feed rate.

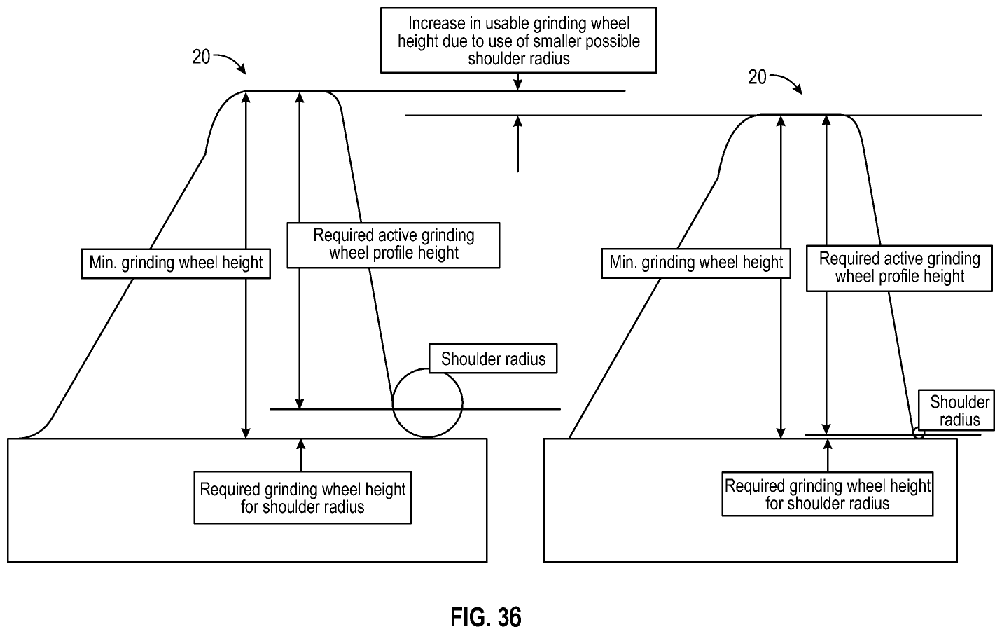

In various embodiments of the invention, it is advantageous that internal radii of a grinding wheel surface, such as a transition between a profile crowning curve and a shoulder radius curve, can be made with internal corner radii smaller than traditional rotary profile generating rolls. A traditional rotary profile generating roll has a tip radius of ˜2.54 mm, which obviates the design of grinding wheel surfaces with shoulder radii less than ˜2.54 mm. This large radius causes grinding wheel designs with large shoulder radii, which increases the minimum grinding wheel height, which reduces the number of dresses possible for a grinding wheel. A change from a 3 mm shoulder radius to a 0.5 mm shoulder radius can increase the number of workpieces per grinding wheel (see FIG. 36), an important measure of tooling cost, by approximately 10 to 20 workpieces per grinding wheel.

The schematic flow chart diagrams, such as depicted in FIG. 17, are included herein are generally set forth as logical flow chart diagrams. As such, the depicted order and labeled steps are indicative of one embodiment of the presented process. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the process. For example, an arrow may indicate a waiting or monitoring period of unspecified duration between enumerated steps of the depicted process. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and program code.

Additionally, the order in which a particular method occurs may or may not strictly adhere to the order of the corresponding steps shown. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures. For example, steps 208-216 may be executed concurrently in some embodiments. In other embodiments, steps 208-216 may be executed sequentially for a single circular curve.

As will be appreciated by one skilled in the art, aspects of the present invention may be embodied as a system, method, and/or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module,” or “system.” Furthermore, aspects of the present invention may take the form of a computer program product embodied in one or more computer readable medium(s) having program code embodied thereon.

The processes described herein above may be implemented in software for execution by various types of processors. An identified module of computer readable program code may, for instance, comprise one or more physical or logical blocks of computer instructions which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of computer readable program code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. Where a module or portions of a module are implemented in software, the computer readable program code may be stored and/or propagated on in one or more computer readable medium(s).

The computer readable medium may be a tangible computer readable storage medium storing the computer readable program code. The computer readable storage medium may be, for example, but not limited to, an electronic, magnetic, optical, electromagnetic, infrared, holographic, micromechanical, or semiconductor system, apparatus, or device, or any suitable combination of the foregoing.

More specific examples of the computer readable medium may include but are not limited to a portable computer diskette, a hard disk, a random access memory (RAM), a read-only memory (ROM), an erasable programmable read-only memory (EPROM or Flash memory), a portable compact disc read-only memory (CD-ROM), a digital versatile disc (DVD), an optical storage device, a magnetic storage device, a holographic storage medium, a micromechanical storage device, or any suitable combination of the foregoing. In the context of this document, a computer readable storage medium may be any tangible medium that can contain, and/or store computer readable program code for use by and/or in connection with an instruction execution system, apparatus, or device.

The computer readable medium may also be a computer readable signal medium. A computer readable signal medium may include a propagated data signal with computer readable program code embodied therein, for example, in baseband or as part of a carrier wave. Such a propagated signal may take any of a variety of forms, including, but not limited to, electrical, electro-magnetic, magnetic, optical, or any suitable combination thereof. A computer readable signal medium may be any computer readable medium that is not a computer readable storage medium and that can communicate, propagate, or transport computer readable program code for use by or in connection with an instruction execution system, apparatus, or device. Computer readable program code embodied on a computer readable signal medium may be transmitted using any appropriate medium, including but not limited to wireless, wireline, optical fiber cable, Radio Frequency (RF), or the like, or any suitable combination of the foregoing.

In one embodiment, the computer readable medium may comprise a combination of one or more computer readable storage mediums and one or more computer readable signal mediums. For example, computer readable program code may be both propagated as an electro-magnetic signal through a fiber optic cable for execution by a processor and stored on RAM storage device for execution by the processor.

While the foregoing disclosure discusses illustrative embodiments, it should be noted that various changes and modifications could be made herein without departing from the scope of the described embodiments as defined by the appended claims. Accordingly, the described embodiments are intended to embrace all such alterations, modifications and variations that fall within scope of the appended claims. Furthermore, although elements of the described embodiments may be described or claimed in the singular, the plural is contemplated unless limitation to the singular is explicitly stated. Additionally, all or a portion of any embodiment may be utilized with all or a portion of any other embodiments, unless stated otherwise.

1. Method for plunge dressing of a spiral bevel gear-grinding wheel, the method comprising:
providing a dressing roll for plunge dressing of a spiral bevel gear-grinding wheel, the dressing roll including:
a body portion having an axis of rotation, a radial extent about said axis, and an axial extent, the body portion integrally comprising:
a base portion configured for connection to a drive motor,
a first cutting surface, and
a second cutting surface; and
plunge dressing of the spiral bevel gear-grinding wheel.

2. The method of claim 1, further comprising:
determining whether interference will occur between the grinding wheel and the dressing roll.

3. The method of claim 1, wherein the second cutting surface includes a radial extent less than a radial extent of the first cutting surface.

4. The method of claim 1, wherein plunge dressing of the spiral bevel gear-grinding wheel is executed by:
moving the dressing roll and grinding wheel together so that line contact is made between a portion of the radial extent of the dressing roll and a convex surface of the grinding wheel,
releasing the plunge,
moving the dressing roll and grinding wheel together so that line contact is made between a portion of the radial extent of the dressing roll and a concave surface of the grinding wheel.

5. The method of claim 4, further comprising:
rotating the dressing roll and the grinding wheel within a 0-degree to 20-degree range with respect to the axial planes of rotation during plunge dressing of the convex grinding wheel surface; and
rotating the dressing roll and the grinding wheel within a 0-degree to 20-degree range with respect to the axial planes of rotation during plunge dressing of the concave grinding wheel surface.

6. The method of claim 1, wherein plunge dressing of the spiral bevel gear-grinding wheel is executed by:
moving the dressing roll and grinding wheel together so that line contact is made between a portion of the radial extent of the dressing roll and a convex surface of the grinding wheel,
releasing the plunge,
tilting one of the dressing roll and the grinding wheel,
moving the dressing roll and grinding wheel together so that line contact is made between a portion of the radial extent of the dressing roll and a concave surface of the grinding wheel.

7. The method of claim 6, further comprising:
rotating the dressing roll and the grinding wheel within a 0-degree to 20-degree range with respect to the axial planes of rotation during plunge dressing of the convex grinding wheel surface; and
rotating the dressing roll and the grinding wheel within a 0-degree to 20-degree range with respect to the axial planes of rotation during plunge dressing of the concave grinding wheel surface.

8. The method of claim 1, wherein plunge dressing of the spiral bevel gear-grinding wheel is executed by:
moving the dressing roll and grinding wheel together so that line contact is made between a portion of the radial extent of the dressing roll and simultaneously on both a convex surface of the grinding wheel and a concave surface of the grinding wheel and a tip portion of the grinding wheel.

9. The method of claim 8, wherein the dressing roll comprises a circumferential channel having a first side portion for contacting the convex surface of the grinding wheel and a second side portion for contacting the concave surface of the grinding wheel; and further comprising:
rotating the dressing roll and the grinding wheel within a 60-degree to 95-degree range with respect to the axial planes of rotation during plunge dressing of the concave and convex grinding wheel surfaces.

10. The method of claim 1, wherein the dressing roll comprises a circumferential channel having a first side portion for contacting a convex surface of the grinding wheel and a second side portion for contacting a concave surface of the grinding wheel, and wherein plunge dressing of the spiral bevel gear-grinding wheel is executing by:
moving the dressing roll and grinding wheel together so that line contact is made between the first side portion of the dressing roll and the convex surface of the grinding wheel,
releasing the plunge, and
moving the dressing roll and grinding wheel together so that line contact is made between the second portion of the dressing roll and the concave surface of the grinding wheel.

11. The method of claim 10, and further comprising:
rotating the dressing roll and the grinding wheel within a 60-degree to 95-degree range with respect to the axial planes of rotation during plunge dressing of the convex grinding wheel surface.

12. The method of claim 1, wherein the dressing roll comprises a circumferential channel having a first side portion for contacting a convex surface of the grinding wheel and a second side portion for contacting a concave surface of the grinding wheel, and wherein plunge dressing of the spiral bevel gear-grinding wheel is executing by:
moving the dressing roll and the grinding wheel together so that line contact is made between the first side portion of the dressing roll and the convex surface of the grinding wheel,
tilting one of the dressing roll and the grinding wheel, and
moving the dressing roll and grinding wheel together so that line contact is made between the second portion of the dressing roll and the concave surface of the grinding wheel.

13. The method of claim 10, and further comprising:
rotating the dressing roll and the grinding wheel within a 60-degree to 95-degree range with respect to the axial planes of rotation during plunge dressing of the convex grinding wheel surface; and
rotating the dressing roll and the grinding wheel within a 0-degree to 90-degree range with respect to the axial planes of rotation during plunge dressing of the concave grinding wheel surface, and wherein the tilting is executed within the 0-degree to 95-degree range.

14. The method of claim 1, wherein plunge dressing of the spiral bevel gear-grinding wheel is executed by:
rotating the dressing roll and grinding wheel within a 0-degree to 95-degree axial plane range,
moving the dressing roll and grinding wheel together so that line contact is made between a portion of the radial extent of the dressing roll and a convex surface of the grinding wheel,
releasing the plunge, and
moving the dressing roll and grinding wheel together so that line contact is made between a portion of the radial extent of the dressing roll and a concave surface of the grinding wheel.

15. The method of claim 12, wherein the dressing roll comprises a circumferential protrusion having a first side portion for contacting a convex surface of the grinding wheel and a second side portion for contacting a concave surface of the grinding wheel.

16. The method of claim 13, further comprising:
rotating the dressing roll and the grinding wheel within a 60-degree to 95-degree range with respect to the axial planes of rotation during plunge dressing of the convex grinding wheel surface; and
rotating the dressing roll and the grinding wheel within a 0-degree to 95-degree range with respect to the axial planes of rotation during plunge dressing of the concave grinding wheel surface.

17. The method of claim 15, further comprising:
tilting one of the dressing roll and the grinding wheel within the 0-degree to 95-degree range subsequent to the releasing.

18. The method of claim 1, wherein plunge dressing of the spiral bevel gear-grinding wheel is executed by:
rotating the dressing roll and grinding wheel within a 0-degree to 95-degree axial plane range with respect to one another,
moving the dressing roll and grinding wheel together so that line contact is made between a portion of the radial extent of the dressing roll and a convex surface of the grinding wheel,
releasing the plunge,
tilting one of the dressing roll and the grinding wheel, and moving the dressing roll and grinding wheel together so that line contact is made between a portion of the radial extent of the dressing roll and a concave surface of the grinding wheel.

19. The method of claim 1, wherein plunge dressing of the spiral bevel gear-grinding wheel is executed by:
rotating the dressing roll and grinding wheel within a 60-degree to 95-degree axial plane range with respect to one another,
moving the dressing roll and grinding wheel together so that line contact is made between a circumferential protrusion the dressing roll and simultaneously on both side portions of a circumferential channel of the grinding wheel.

20. The method of claim 1, wherein plunge dressing of the spiral bevel gear-grinding wheel is executed by:
moving the dressing roll and grinding wheel together so that line contact is made between a first portion of the radial extent of the dressing roll and a convex surface of the grinding wheel,
tilting one of the dressing roll and the grinding wheel,
moving the dressing roll and grinding wheel together so that line contact is made between a second portion of the radial extent of the dressing roll and a concave surface of the grinding wheel.

21. The method of claim 20, further comprising:
rotating the dressing roll and the grinding wheel within a 60-degree to 95-degree range with respect to the axial planes of rotation during plunge dressing of the convex grinding wheel surface; and
rotating the dressing roll and the grinding wheel within a 60-degree to 95-degree range with respect to the axial planes of rotation during plunge dressing of the concave grinding wheel surface.

22. The method of claim 20, further comprising:
tilting one of the dressing roll and the grinding wheel within the 60-degree to 95-degree range subsequent to the releasing.

23. The method of claim 1, further comprising:
determining an amount corresponding to a side shift of the dressing roll; and
plunge dressing of the spiral bevel gear-grinding wheel based upon the determining.

24. The method of claim 1, wherein determining whether interference will occur between the grinding wheel and the dressing roll comprises:
receiving grinding wheel operating parameters including a geometric profile;
calculating a maximum dressing roll tilt for a first surface of the grinding wheel;
defining dressing roll tilt for a second surface of the grinding wheel and design dressing roll;
calculating a plurality of sections of the dressing roll;
generating a table of X, Y, and Z coordinates for each of the plurality of sections;
determining a corresponding grinding wheel diameter and Z values at X and Y points based upon information stored on the table;
calculating interference between dressing roll X, Y, and Z points and grinding wheel X, Y, and Z points; and
plunge dressing of the spiral bevel gear-grinding wheel based upon the calculating interference between dressing roll X, Y, and Z points and grinding wheel X, Y, and Z points.

25. The method of claim 1, further comprising:
receiving operating parameters associated with dressing the grinding wheel and a geometric profile of the grinding wheel; and
plunge dressing of the spiral bevel gear-grinding wheel based upon the operating parameters and the geometric profile, wherein the operating parameters are determined, in part, based upon interference assessments between the grinding wheel and the dressing roll.

26. A dressing roll for plunge dressing of a spiral bevel gear-grinding wheel, the dressing roll comprising:
a body portion having an axis of rotation, a radial extent about said axis, and an axial extent, the body portion integrally comprising:
a base portion configured for connection to a drive motor,
a first cutting surface having an S-shaped cross sectional line of contact with the grinding wheel, and
a second cutting surface having an oppositely aligned, with respect to the first cutting surface shape, S-shaped cross sectional line of contact, with the grinding wheel.

27. A dressing roll for plunge dressing of a spiral bevel gear-grinding wheel, the dressing roll comprising:
a body portion having an axis of rotation, a radial extent about said axis, and an axial extent, the body portion integrally comprising:
a base portion configured for connection to a drive motor,
a first cutting surface corresponding to a first line of contact with the grinding wheel from a tip position on the grinding wheel to a shoulder portion, and
a second cutting surface corresponding to a second line of contact with the grinding wheel from the tip position on the grinding wheel to a second shoulder position.

28. The dressing roll of claim 27, wherein the first line of contact with the grinding wheel further comprises one of a cross-sectional line associated with a tip radius surface, a protuberance surface, a profile crown surface, and a shoulder portion surface.
